(19) United States
(12) Patent Application Publication
(10) Pub. No.: US 2013/0275973 A1
(43) Pub. Date: Oct. 17, 2013

(54) VIRTUALISATION SYSTEM

(71) Applicants: Dan Greenfield, Cambridge (GB); Alban Rrustemi, Cambridge (GB)

(72) Inventors: Dan Greenfield, Cambridge (GB); Alban Rrustemi, Cambridge (GB)

(73) Assignee: FONLEAP LIMITED, Cambridge (GB)

(21) Appl. No.: 13/820,460

(22) PCT Filed: Aug. 23, 2011
(86) PCT No.: PCT/GB11/51584

§ 371 Date: Mar. 1, 2013

(30) Foreign Application Priority Data
Sep. 6, 2010 (GB) 1014751.0

(51) Int. Cl. G06F 9/455

(52) U.S. Cl. CPC G06F 9/45533
USPC 718/1

(57) ABSTRACT

This invention relates to virtualised systems, in particular to portable virtualised systems whereby a user is able to transfer their desktop environment from one computing machine to another. A method of providing a transferable computing environment between a computing machine and a portable storage device is described whereby the operational state of the computing environment is maintained after the transfer. A virtual machine is portioned into a common portion and a second portion, the second portion storing a state of operation of the virtual machine and the state of applications. The second portion is transferred to a computing machine to be used in combination with the common portion of the virtual machine already residing on the computing machine.

### FIELD OF THE INVENTION

This invention relates to virtualised systems, in particular to portable virtualised systems whereby a user is able to transfer their desktop environment from one computer to another computer.

### BACKGROUND TO THE INVENTION

There is a desire to provide a full-speed, continuous, portable experience of one's desktop applications and files, wherever one can go.

In corporate environments for example, a company may wish to allow their staff to work in the office on a desktop computer, and then transfer their computing environment to a laptop computer so that they may continue working on the same applications when out in the field or working at home. In many situations, such as when the business traveler is travelling (flying for example) there is no internet access and so using systems such as remote VPN access are not possible.

In the home, a student may wish to transfer their desktop environment, applications and documents to a storage device, then restore their desktop environment and continue working on documents on a shared computer in a library or a university computer room for example.

One approach of enabling this portability is to use Virtual Machines whereby a copy of the entire Virtual Machine is saved, moved onto a portable storage device, and then restored onto another machine. However, running Virtual Machines off external storage devices, in particular USB flash storage devices, can be problematic. This is because the performance of external inexpensive commodity flash storage devices can be low (especially on writes) compared to regular hard disk drives (HDDs). As a result, restoring and saving Virtual Machines can take a long time.

Examples of existing approaches to providing a portable desktop experience include the following:

Remote-desktop software allows a device to connect to a desktop over the Internet or a local network where the network carries the desktop display information to the device, and the network carries input information from the device to the desktop. Such a desktop may be that of an actually running PC on hardware, or a virtual machine's desktop running on a server. This approach is a reasonable solution if the bandwidth is high and the latency low, such as within a local network, however when connecting to work from home, or worse—from another city or country, the greatly increased latency, especially over a VPN, and the reduced bandwidth can lead to a poor quality user experience. Moreover, where there is no Internet connectivity, there is likewise no access. Whilst travelling in other countries with roaming charges for connectivity, this can also be a prohibitively expensive solution.

Portable Desktops on Flash Drives (such as U3, PortableApps, Ceedo) allow one to run Windows applications off the USB flash drive when plugged into a Windows-based PC machine. With these solutions, users can launch applications, access their files on the USB flash drive, and when done, save their files and close these applications again, which can then be repeated on another Windows-based PC. This, however, is not a continuous portable experience, as they must explicitly save all their files, and at their destination, relaunch their applications and reopen these files. It is more desirable if their desktop is preserved as they left it and could merely be resumed at their destination.

Cloud storage solutions (such as DropBox)—these provide a cloud-based store of files that can be accessed wherever there is Internet connectivity and if the cloud-based storage driver is installed. One may even include applications in this storage. Unfortunately the latency of access and low bandwidth typically makes running larger applications, such as Office productivity software, an unpleasant experience. Moreover, these solutions only allow one to take files, instead of their entire desktop environment.

Cloud-based applications (such as Google Docs)—in this approach, the entire desktop is replaced with web-based applications. Whilst the bulk of computation and storage occurs on cloud servers, some local processing may also occur such as through Javascript. Another approach is Java-based deployment of applications. Unfortunately, these do not provide as rich an experience as a native application that runs locally. For example, Google Earth is a much richer, faster application than Google Maps is.

Running Hardware Virtual Machines on a Hypervisor directly off a typical USB flash memory device is an unpleasant experience, due to the much lower read and write bandwidths available. It can take on the order many minutes to restore a reasonable 2 GB virtual-machine desktop, and it can take even longer to save it again. Ideally, one would like to provide an almost instant-on experience. Typically they can run a full OS, but need a portion running in kernel-mode to be installed to handle privileged instructions.

Streamed Virtual Machines—allow a PC to stream the Virtual Machine state over the network. This unfortunately still requires network connectivity and server infrastructure in order to ensure synchronisation with the Virtual Machine image on the server.

Desktop Hosted from a portable device with networking capability. The palm sized OQO device from 2004 was capable of running Linux. Graphical applications run on the OQO device could connect over the network to a X-windows server running on a host PC, and thus allow the application's windows to be seen and interacted with on the host PC as though it were running locally on the PC. However, this solution relies on the relatively poorer computational power of the portable device compared to the host PC, resulting in an inferior user-experience.

Given the challenges faced with the above example, there is therefore a need for a full-speed, continuous, portable experience of one's desktop applications and files, wherever one can go.

### SUMMARY OF THE INVENTION

According to a first aspect of the invention there is provided a method of providing a transferable computing environment, wherein said computing environment is operable on a first, computing machine and is able to be transferred to a second, portable device, and wherein said transfer retains an operational state of said computing environment, the method comprising: providing a said first computing machine, wherein said first computing machine has a host operating system (OS) and a virtual machine monitor (VMM) running on said host OS; providing a plurality of virtual machines each able to run on said VMM, wherein each said virtual machine (VM) includes a guest OS to run using said VM and an application residing in said VM; portioning each said virtual machine into first and second portions, wherein said first portion of said VM comprises at least a common portion of said virtual machines shared between said plurality of virtual machines, said common portion including at least a common part of said guest OS, and wherein said second portion of said VM comprises application state data defining a state of operation of said application specific to operation of the application in the VM; providing said first computing machine with at least a useable part of one of said virtual machines; using said application in said at least one VM on said first computing machine to define a said operational state of said application; and transferring at least part of said second portion of said at least one VM to said portable device to enable said application in said at least one VM to be used, in combination with said common portion of said virtual machines, on a second computing machine.

The skilled person will understand that the VMM may include or be linked or integrated with additional code modules to perform functions such as the Resource Sharing Manager, Paired Application Coherence Manager, Shared File System Manager, License Management, SPSD-to-VMM Transfer, File System Handling as described in detail later.

Changes made to the VM state are transferred (transfer could be: copied; moved; copied then the source deleted; or directly written to the portable device) from the first computing machine (first PC) thereby reducing the volume of data needing to be stored on the portable device in comparison to transferring the entire VM. The portable device thus stores an accurate, consistent and recent view of the memory state of the VM (there is no need for the original VM running on the first computing machine to be deleted as it may still be running). Other state, such as the disk state may use the portable device as the storage mechanism thus the transferring may be directly writing to the storage device rather than storing on the computing machine and then subsequently transferring (by copying, moving, etc). A further benefit is achieved on restoring system state to a second computing machine (second PC) as there is less data to transfer or copy over to the second machine. The VM can be portioned into first and second portions—the first portion comprising the standard foundation VM image (including memory state and disk/file-system state) and any necessary standardised patches for example, with the second portion comprising the deployed VM application for example. This provides for a faster restoration of state on the second computing machine thereby bringing the virtualised machine into a useable state much faster than conventional approaches. Moreover, the first portion of the VM could be loaded in advance and remain resident at the first and second computing machines.

In preferred embodiments said second portion of a VM has an application portion configured to cooperate with said common portion of said VMs to implement an application and an application state update portion comprising said application difference data and OS difference data together defining changes to a state of both said application and said guest OS resulting from operation of said application on said guest OS, the method further comprising transferring at least part of said application state update portion of said VM between said portable device and said first computing machine or a further computing machine.

In some preferred embodiments said computing machine may lack said application portion, and wherein use of said application in a said computing machine requires connection of said portable device to a said computing machine.

The transferring of the second portion to the portable device can be indirectly from the first computing machine or alternatively could be directly to the portable device, for example via a 3G connection thereby allowing applications to be installed on demand in the portable device.

The transfer of state to the second computing machine may also be prioritised based upon a history of usage on the first computing machine (such usage can be further stored on the portable device when the VM state is copied onto the portable device for example). Advantageously this may allow the highest priority state (for example relating to features the user is most likely to use straightaway) to be transferred to the second computing machine in advance of other state; the restored VM may then be usable on the second computer machine whilst further state data is being transferred—the user does not need to wait for all the state to be transferred before being able to use the VM. Additional benefits include reducing the memory footprint on the computing machines—each VM has a common portion thus reducing the memory footprint. This makes hardware VMs at the application level more practical, and consequently this has further advantages. Application level VMs allow more security and isolation, further allowing individual applications to be saved, paused and restored without closing them down. Furthermore, individual applications may be migrated from one machine to another instead of the entire desktop. The VMs may be partitioned in a standardised manner by construction thereby allowing the common portion to be deployed across many physical machines. In addition, when deployed, an application that needs to be distributed may only require the second portion to be distributions as the first portion may be common, thereby reducing transmission requirements as the second portion of the application will be smaller. Similarly for patches, the standardised first portion allows standard patches to the OS/environment (first portion) to be done on ‘live’ application at the VM level, with this being transparent to the application/second portion.

In some preferred embodiments said computing machine lacks said application portion, and wherein use of said application in a said computing machine requires connection of said portable device to a said computing machine. This allows the application to loaded into memory on the computing machine from the portable device. The portable device may then be optionally disconnected from the computing machine.

According to a further aspect of the invention there is provided a method of providing a transferable computing environment between a plurality of computing machines, the method comprising: providing each of a plurality of computing machines with both a virtual machine monitor (VMM) and a host OS, providing a virtual machine (VM) able to run on said VMM, wherein said VM includes a guest OS to run using said VM and an application residing in said VM, portioning said VM into first and second portions, wherein said first portion of said VM comprises at least a common portion of said VM common to each of said plurality of computing machines, said common portion including at least a common part of said guest OS, and wherein said second portion of said VM comprises application state data defining a state of operation of said application specific to operation of the application in the VM, providing a portable device with said second portion of said virtual machine; and transferring at least a useable part of said second portion of said VM from said portable device to enable said application in said VM to be used, in combination with said common portion of said virtual machines, on a first of said plurality of computing machines.

In some preferred embodiments the method further comprises transferring said at least a useable part of said second portion of said VM from said portable device to enable said application in said VM to be used, in combination with said common portion of said virtual machines, on a second of said plurality of computing machines. Thus changes can be migrated from the portable device to a second computing machine

In some preferred embodiments the method further comprises updating said second portion of said VM on said portable device using data from use of said application on said first of said plurality of computing machines prior to transferring said second portion of said VM from said portable device to said second of said plurality of computing machines. Thus the second portion on the portable device can be updated with only changes to this information from the first computing machine, then transferred to a second computing machine.

In some preferred embodiments the method further comprises a plurality of such virtual machines, each VM including a guest OS to run using said VM and an application residing in said VM, wherein each VM comprises said common portion shared between said plurality of virtual machines, wherein said common portion of said virtual machines is common to each of said plurality of computing machines; transferring at least said useable part of said second portion of each of said plurality of VMs from said portable device to enable each of said application in said VM to be used, in combination with said first portion of said virtual machines, on said first of said plurality of computing machines.

In some preferred embodiments said second portion of a VM has an application portion configured to cooperate with said common portion to implement an application and an application state update portion comprising said application difference data and OS difference data together defining changes to a state of both said application and said guest OS resulting from operation of said application on said guest OS, the method further comprising transferring at least part of said application state update portion of said VM from said first of said plurality of computing machines to said portable device, and transferring said application state update portion from said portable device to said second of said plurality of computing machines.

In some embodiments the said second portion of said VM may be transferred over a network from a server to said portable storage device, for example direct from a server to a phone. More preferably the second portion is transferred over a network from said server to an intermediate computing machine, for example a computer connected to the phone; and then transferred from said intermediate computing machine to said portable storage device. The intermediate computing machine may be one of the plurality of computer machines or could be an independent, separate computing machine.

Preferably said plurality of VMs includes at least one subset of application suite VMs comprising a respective subset of said applications, wherein said applications of said subset are interoperable, wherein said application state update portions of said application suite VMs include interprocess communication software state data common to said subset of applications, and wherein said transferring comprises transferring said common interprocess communication software state data of said application suite VMs to said portable device. Preferably said application state data comprises data defining a change in said application state data from one application state to another.

To allow for a rapid load and save of state in individual applications it can be beneficial to store each application in its own separate VM running in its own VM environment. If an application is part of a suite of applications that wish to communicate data between each other, a shared memory layer (IPC layer) can be used allowing inter-process communication between applications each running in their own VM environment. The inter-process communication software state data may comprise the IPC layer and common libraries to the suite of applications.

Preferably said guest OS and said host OS include corresponding files, further comprising a table linking one or more files of said guest OS to said corresponding files of said host OS to enable a said corresponding file to be retrieved, and wherein said guest OS lacks said corresponding file. Preferably said using of said application on said first computing machine comprises retrieving at least some of the data from a said corresponding file from the host OS via the guest OS. The table is preferably stored in the VMM. Providing such a table/links allows the guest OS has the same view of the linked files regardless of the host machine, host OS and irrespective of where the files are stored on the host file system. The files may not even be stored on the host OS and may be fetched from the internet instead. In all these scenarios, the guest OS sees these files as regular files, with the VMM hiding the details of accesses.

A meta-file system (MFS) provides a bridge to files in the underlying host's OS. A table, database or other means of bridging/redirecting may be used to achieve this. This allows files existing on the host OS to be accessed by the guest OS/VM. These files may be fonts or libraries for example that cannot be distributed with the guest OS due to licensing restrictions. Additionally, this also allows the footprint of the deployed guest OS to be reduced.

Preferred embodiments further comprise storing platform independent property data on said portable device for said application in said at least one VM, said platform independent property data comprising data defining a state of said application independent of a processor or operating system on which said application is executing, and using a corresponding mobile version of said application in said at least one VM on said portable device in combination with said common portion of said virtual machines by accessing said platform independent property data using said corresponding mobile version of said application.

An application that runs in a VM and a corresponding mobile version of the application running on the portable device can be paired together allowing platform independent property data to be accessed by the portable device. This allows a user to continue working/accessing data directly from their portable device (e.g. smartphone) when they have no connection to one of the computing devices. To maintain coherence, a paired application coherence manager (PACM) may be used. The platform independent property data can be accessed by paired applications on the portable device (the smart personal storage device—SPSD) and inside the VMM to provide a seamless experience when working across the different devices. When a user changes from the computer to the SPSD, any paired application state (e.g. open windows, the clipboard data for example) is then available to the user on the SPSD. Similarly, when the user changes from the SPSD to the computer, progress made on the SPSD is made available to the user when they connect back to the computer.

Preferably the method further comprises storing a licence for said application in said at least one VM on said portable device, cryptographically linked to a unique identifier of one or more of: said portable device, a user of said portable device, a telecoms service provider providing a telecoms service to said portable device, and a manufacturer of said portable device. Advantageously this may tie the licence (providing usage restrictions or permissions) to the user based on identification details related to their portable device. This enables a user to move their licences between computers and ensure that they have the appropriate licences for applications that they wish to use. This also allows telecoms service providers and manufacturers of said portable devices to bundle software that is accessible only while the user remains with that telecom provider or manufacturer.

Thus in another aspect of the invention the invention provides a method of providing a transferable computing environment comprising storing a licence for said application in said at least one VM on said portable device, cryptographically linked to a unique identifier of one or more of: said portable device, a user of said portable device, a telecoms service provider providing a telecoms service to said portable device, and a manufacturer of said portable device. Preferably the VM is according to one or more aspect/embodiments of the invention as described above.

In some preferred embodiments of the method said licence, or tokens enabling use of said licence, is configured to automatically expire at regular intervals, the method further comprising refreshing said licence to maintain usability of said application in said at least one VM. The refreshing may be done by the portable device, or alternatively may be done using the VMM on the host PC and then stored on the portable device. Time limiting/refreshing the licence (through the use of licence tokens for example) ensures that if a portable device is lost or deactivated/sold, then the licensing permissions expire. Upon being made aware of the loss or deactivation/sale the licensor can prevent updated licences or tokens enabling use of the licence being issued to that particular device until a new user registers that same device and their own selected suite of applications.

In preferred embodiments the method further comprises transferring at least said second portion of said at least one VM to a third, computing machine, and using said application in said at least one VM on said third computing machine, wherein one or both of said application portion and said application state update portion of said VM include at least a portion of a file associated with or licensed with said host OS, the method further comprising tagging said transferred portion of said at least one VM to indicate presence of said portion of said file of said host OS, and wherein said using of said application in said at least one VM on said third computing device further comprises checking that said at least a portion of said file indicated by said tagging exists on said third computing device, and restricting use of said application in said at least one VM on said third computing device if said at least a portion of said file indicated by said tagging does not exist on said third computing device.

The tagging allows the presence of licence keys/files to be verified for a VM application to ensure that an application cannot run without the appropriate usage permissions. If the conditions are not complied with (for example the licence file not being present on the third computer machine) the application remains suspended and may not be brought up into use on the third computer device.

Preferably the method further comprises providing an interface application to enable use of resources of said portable device by said application in said at least one VM when operating on said portable device, and wherein said VM and one or both of said interface application and said guest OS include an API to enable respectively, one or both of use of a resource of said first computing machine by said application in said at least one VM on said portable device, and use of a resource of said portable device by said application in said at least one VM on said first computing machine. Such capabilities allow applications on the VM to use resources on the portable device and/or vice versa. A resource sharing machine may provide the API to share resources between the portable device (SPSD) and host side VMM. The VMM instance may inform the SPSD of the capabilities of the VMM, and the SPSD instance may inform the VMM of the capabilities of the SPSD. Furthermore, any native application on the portable device may also be able to use resources on attached computing machine through the same interface application.

Preferably the method of providing a transferable computing environment further comprises transferring at least said second portion of said at least one VM to a third, computing machine, and using said application in said at least one VM on said third computing machine, and further comprising suspending operation of a host OS of said third computing machine during use of said application in said at least one VM such that after said use of application in said at least one VM said suspended state is restorable.

When a user wishes to run their portable computing environment, the host OS on the third computing machine can be suspended and its state preserved, and a customised OS kernel, for example, can take control of the third computing machine and run the portable computing environment. Once work on the portable computing environment is finished, the preserved state of the third machine is restored thereby returning the third computing machine back to its original state. Return to the suspended state includes restoring and resuming components such as device drivers and memory location content for example.

According to a further aspect of the invention there is provided a computing device or portable device storing a VM, wherein the VM is in particular as described in the first aspect of the invention.

According to a further aspect of the invention there is provided a method of transferring a transferable computing environment between a plurality of computing machines, the method comprising: providing each of a plurality of computing machines with a common computing environment, said common computing environment comprising a guest operating system (OS) and a virtual machine monitor (VMM), said guest OS and said VMM being common to each of said plurality of computing machines, portioning a virtual machine (VM) operable to run on said VMM into first and second portions, said first portion comprising a common portion of said VM common to each of said plurality of computing machines, said second portion defining a state of operation of said VM, said common computing environment on each of said plurality of computing machines further comprising said first portion of said VM; providing a first of said plurality of computing machines with said second portion of said VM; transferring said second portion of said VM to a portable device; and transferring said second portion of said VM from said portable device to a second of said plurality of computing machines.

Each of the computing machines has a base image (the common computing environment) and changes to state from in the VM are transferred (transfer could be: copied; moved; copied then the source deleted; or directly written to the portable device) between the computing machines using a portable device. Typically the first of the plurality of computer machines is considered the ‘base’ computer and used to construct the base image used across all the computers in the ‘ring’. Thus the computing machines form a ‘ring of synchronisation’ with the portable device (SPSD) storing and transferring only the deltas (changes) on the portable device reducing storage requirements and also enabling a fast transfer of state from one machine to the other. These computers are considered to be actively used by a single user and therefore has the benefit of further reducing the amount of state carried on the portable device.

In embodiments said first portion of said VM further comprises one or more applications common to each of said plurality of computing machines, and wherein said second portion of said VM further comprises application state data (such as memory state, execution state and file system state, which may include window layout, clipboard status, for example). In embodiments the method preferably further comprises storing user data on said portable device, and when connected to one of said plurality of computing machines, said VM accessing said user data on said portable device.

The common computing environment may provide a set of pre-installed applications on each computing machine, with changes to state (e.g. configuration of the application and/or user data within the applications) also being transferred using the portable device. User and application data is then always available to the owner of the portable device so that they may move from one computer to another and be presented with applications running in the same state (and files loaded up into the same state). The execution state is captured and restored.

Preferably the method further comprises storing user data on said portable device, and when connected to one of said plurality of computing machines, said VM accessing said user data on said portable device, thereby allowing access to user content, such as documents etc stored on the portable device without needing to locally store the files on each computer machine.

Preferably the method further comprises storing VM application data in said common computing environment (ring image), transferring VM application change data defining changes to said VM application data made by said first of said plurality of computing machines from said first of said plurality of computing machines to said portable device, and updating said VM application data in said common computing environment on said second of said plurality of computing machines using said VM application change data. If a user regularly uses several different computing machines, this can reduce the amount of VM application files that need to be transferred between computing machines by providing a base set of VM application files with each common computing environment, i.e. effectively the common computing environment (ring image) provides a snapshot of the system which may include one or more the VM applications as discussed, and/or the file system contents, and device state. These could be files typically used for reference, such as research papers, user manuals and the like, but may also be documents edited and updated. Changes to the user files may then also be transferred using the portable device to other computing devices so that a user is always using the most recent version of the user files.

In some preferred embodiments the method further comprises comparing said user change data with said user data in each of said plurality of computing machines, and dependent on said comparison, removing said user change data from said portable device. The portable device or one or more of the computers may keep track of which computers have been updated to the most recent version of each user file. Once all of the plurality of computing devices have received the latest version of the user file then the user file can be deleted from the portable device thereby reducing storage requirements.

According to a still further aspect of the invention there is provided a portable device for managing and transferring a transferable computing environment, the transferable computing environment comprising a guest operating system (OS), a virtual machine monitor (VMM) running on a host OS, and a virtual machine (VM) running said guest OS, comprising state data items defining a state of operation of said VM, the portable device comprising: an interface for communicating with a computing machine, non-volatile memory to store said state data items, and memory storing priority data defining a preferred transfer order of a plurality of said state data items.

Preferably the portable device further comprises a program store storing code and a processing element coupled to said interface, said non-volatile memory and said program store, the code comprising: code to receive said state data items from a first computing machine via said interface and store said state data items in said non-volatile memory; code to send said plurality of said state data items from said non-volatile memory to said first computing machine or a second computing machine, wherein an order of said sending is dependent on said priority data.

The portable device (smart personal storage device—SPSD) may be a mobile phone, or also a portable memory storage device such as a USB data stick. The portable device receives the state data items (changes in state of the VM) from the first computing machine, stores the data, then uploads it to the second computing machine when connected. Overlapping data may also be merged before storage such that only the most recent version of the data is transferred. The interface for communication may be wired (for example via a USB connection) or wireless (WiFi, Bluetooth or the like). The upload of data is prioritised based upon priority data stored in the portable device.

The prioritisation of transferred data to the second computing machine can be applied to all or some of the data; for example, the order of VM state changes or application files may wish to be prioritised such that a user is able to begin using the second computing machine before all state data is transferred across. By prioritising, for example, based on a prior history of data access (for example, by considering the last accessed application) other data can be transferred in the background whilst a user continues their work on the recently accessed application. The priority data may be part of or provided with the deployed application (but does not need to be). In such a situation the developer of the application may have profiled their application before distribution so that prioritisation of state is known in advance in order to improve the response time when state needs to be restored from the portable computing device. It will be appreciated however that the priority data may also be created, updated and stored on the computing machine and then transferred to the portable device.

In a similar manner, but in the reverse direction, changes in state may also be transferred from the Host to the SPSD in a continuous manner. These changes may be first merged in the SPSD DRAM before writing out to SPSD non-volatile storage so as to reduce the number of writes to non-volatile storage, thereby reducing power consumption, increasing the life of the non-volatile storage, and also ensuring consistency in stored state. This also allows the user to instantly disconnect and walk-away with their portable device while having a consistent usable state, instead of requiring the user to wait a long time to ‘shut-down’/‘close’ their desktop.

Preferably the portable device further comprises code to merge sets of said state data items in volatile memory prior to storing said state data items in non-volatile memory. This can be more energy efficient and increase the lifetime of the non-volatile storage as the number of read and writes to non-volatile memory can be reduced.

Preferably the portable device further comprises code to determine said priority data, wherein said determination is dependent on a usage history of said VM on said first computing machine. The priority data may be determined either by the first computing machine transferring the data to the portable device or alternatively by the portable device receiving the data. The usage history may be used in combination with any prior profiling data or independently of such data. A usage history of the changes may be used to determine an upload priority (a priority queue) for transferring data to the second computing machine. Applications may also have their own priority queue, or alternatively, there may be a combined priority queue for all applications.

In preferred embodiments of the portable device said state data items further comprise platform independent property data comprising data defining a state of said application independent of a processor or operating system on which said application is executing, said portable device further comprising a corresponding portable version of said application in said VM, said portable device further comprising code to access said platform independent property data using said corresponding mobile versions of said application.

The mobile version of an application may access platform independent property data stored on the portable device thereby allowing paired applications to present the user with a similar application state within the corresponding mobile application (such as window layout, open documents, cursor/mouse position) where the portable device has capabilities such as a display and data entry means such as a keyboard or touch screen display (e.g. a mobile phone). Thus even though the underling processor architecture and/or operating system may be different, this data may be independent of such parts therefore binary compatibility is not necessary for such platform independent property data.

The invention further provides a carrier carrying processor control code to implement a method/computation engine as described above, such as the code on the portable device. This code may comprise software and/or hardware definition code—for example in embodiments it is convenient to implement some of the lower level functions in silicon and some of the higher level of functions on a DSP. Thus the carrier may be, for example, a disk, CD- or DVD-ROM, or programmed memory such as read-only memory (Firmware). The code (and/or data) may comprise source, object or executable code in a conventional programming language (interpreted or compiled) such as C, or assembly code, for example for general purpose computer system or a digital signal processor (DSP), or the code may comprise code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

### BRIEF DESCRIPTION OF THE DRAWINGS

These and other aspects of the invention will not be further described, by way of example only, with reference to the accompanying drawings in which:

FIG. 1 shows use of the virtual desktop across host computers;

FIG. 2 shows example usage, first at home, then whilst travelling, and then at the office;

FIG. 3 show portable VM Applications;

FIG. 4 show the case of an application suite;

FIG. 5 shows the file-systems structure for an example VM Application;

FIG. 6 shows the transfer of data mediated by a priority queue;

FIG. 7 shows transfer of Application state from the VMM on the PC to the SPSDs permanent storage (flash);

FIG. 8 shows sharing resources between SPSD and host computer;

FIG. 9 shows the transfer mechanism of a VM Application;

FIG. 10 show the access-policy transfer mechanism for a VM Application;

FIG. 11 shows generation of License Key with terms and license-policies;

FIG. 12 shows one approach for verifying usage restrictions;

FIG. 13 shows another approach for verifying usage restrictions;

FIG. 14 shows access permissions—Authenticating policies in the Centralised Policy Signing model.

FIG. 15 shows access permissions—Authenticating policies in the Decentralised Policy Signing model.

FIG. 16 shows two SPSDs connected to one PC;

FIG. 17 shows handling of file access requests for the MFS;

FIG. 18 shows the process of constructing the MFS database;

FIG. 19 shows the Ring of Synchronisation;

FIG. 20 shows ring-mode VM Applications; and

FIG. 21 shows an example of Portable-Mode operation.

### DETAILED DESCRIPTION OF THE DRAWINGS

A smart portable storage device (SPSD) is a portable device that contains both processing capabilities as well as storage, and display facilities. PDAs fall into this category, as do mobile phones, tablets and palm-held computers.

File-system content comprises data (including files, attributes, permissions and directory structures) stored on a Virtual Disk Image, a compressed storage file such as a .CAB or .ZIP, or as part of an existing file-system such as in a subdirectory of an existing file-system, or as part of a network-mounted file-system.

A VM Application (VM App) comprises any changes in file-system and memory, relative to a standardised VM image (e.g. the Standard Foundation OS memory image and file-system), corresponding to the installation and memory-state (including an unchanged memory-state) of an application in a Virtual Machine

It is desirable to provide a full-speed, continuous, portable experience of one's desktop applications and files, wherever one can go. Ideally, one should be able to freely transport their desktop, complete with applications and files, from one machine to another without being forced to close applications, and even to access their files on the go using their SPSD. For example, one could be working on a PC with various applications open on their desktop, and then leave without closing those applications or saving those files, to catch a train during which they could continue working or examining these files on a SPSD, and then to use another PC at their destination where their entire desktop is available as they left it.

The SPSD is used as a storage device, as an accelerator for applications, as a portable interactive display device, as a security and policy enforcement device (for files, resources, apps and applications), as a resource sharing device for apps and applications, and as an application downloading/installing device. The user carries a SPSD (typically a phone) with them that stores both their user files and portable applications. They can then connect that SPSD to a PC in a wired or wireless fashion (such as via USB, network, WiFi, Bluetooth, etc.). Upon doing so, they have access to their personal desktop environment with any number of portable applications already running, and the ability to launch more applications (such as via a launch bar) that are on the SPSD.

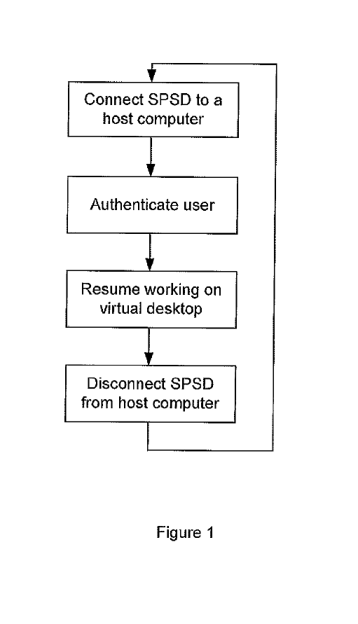

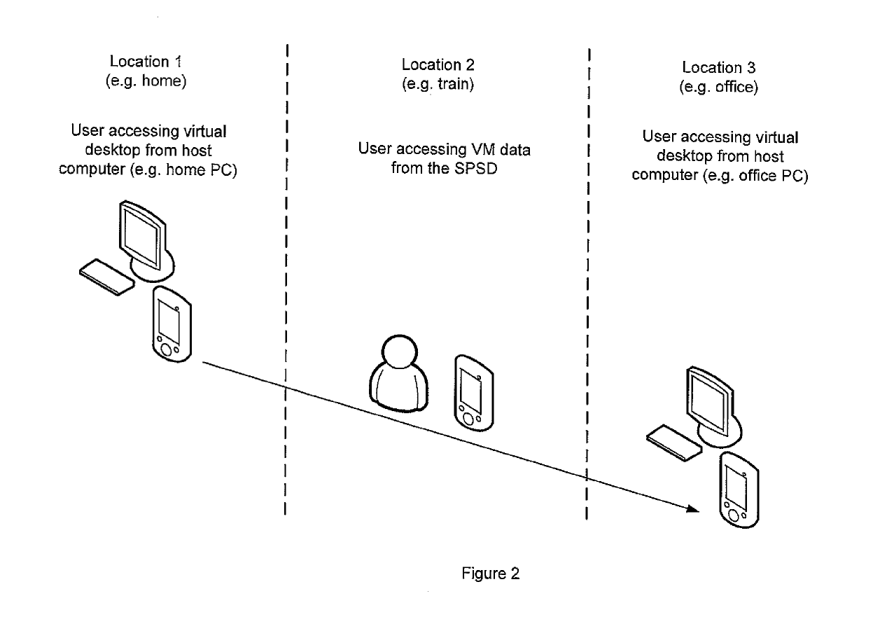

They can work on this desktop, in a similar manner as a regular PC desktop, and when they are done, they can disconnect the SPSD from the desktop, without needing to close these running applications. Instead, the desktop with these running applications are available as they were, when connecting to another (or the same) PC at a later point (FIG. 1 depicts the process of connecting to and disconnecting from a host computer). In the interim period, apps on the SPSD can also access their user files on the SPSD. Furthermore, a paired ‘app with application’ allows more seamless integration between the App on the SPSD and a corresponding Application on the desktop, so that usage in one is mirrored in the other. For example, as illustrated in FIG. 2, at home they could connect their SPSD to their home PC and use their Virtual Desktop, then disconnect and whilst travelling continue to use the files and data from their Virtual Desktop using native apps on the SPSD, and thereafter upon reaching work, connect their SPSD to their work PC and continue using their Virtual Desktop from there.

Machine (para-)virtualisation techniques are used to deliver desktop portability. Moreover, it constitutes a standardised application platform, rather than merely a Virtual Machine Monitor (VMM). Rather than allow you to install any OS, this platform comes with or assumes the presence of a standard OS image of file-system content, memory and device state. The applications (and the whole desktop) are deployed then as changes in memory images, allowing rapid startup. Indeed, pre-loaded executables or library files may even be included with the file-system. In contrast, conventional Virtual Machines rely on loading up the application via the guest OS, by loading in the executable, and shared libraries and accessing configuration files. The approach described herein instead loads up the application, without intervention by the guest OS, as merely a change in its memory and device state.

Moreover this Platform can use a tailored, paravirtualised standard OS image, such that privileged instructions are removed. This can allow the guest OS and applications to run as a user-mode application. This is beneficial for using machines where the user lacks administrator access in order to install drivers (e.g. at Internet Cafes).

As stated earlier, running Virtual Machines off a cheap USB flash storage device can be problematic. This is because the performance of external inexpensive commodity flash storage devices can be low (especially on writes), compared to regular HDDs. As a result, restoring and saving Virtual Machines can take a long time.

The approach in this invention for solving this includes a standardised foundation image deployed across multiple machines. This standard foundation VM image comprises of the OS, and shared libraries, that have a footprint in the memory of the system virtual machine, and in non-volatile storage. The SPSD stores only the modifications to this standardised foundation image. This drastically reduces the amount of data that needs to be transferred to and from the SPSD, thereby improving the performance of the VM execution. The VM execution of the portable virtual desktop can be further improved by prioritising the transport of data from the SPSD to the Host machine based on temporal and spatial locality observations. This prioritised transfer mitigates latency and therefore improves the response time of the portable virtual desktop.

The end user experience is of particular concern—it is undesirable for users to wait minutes before they can use their desktop (the ‘bring-up latency’), from the expressed intention of restoring the desktop, to a usable state. One of the aims of this invention is to reduce ‘bring-up latency’ by orders of magnitude than existing solutions utilising flash memory.

### Standardised Foundation Image

(Ultra-Low Latency Bringup Virtual Machine Platform)

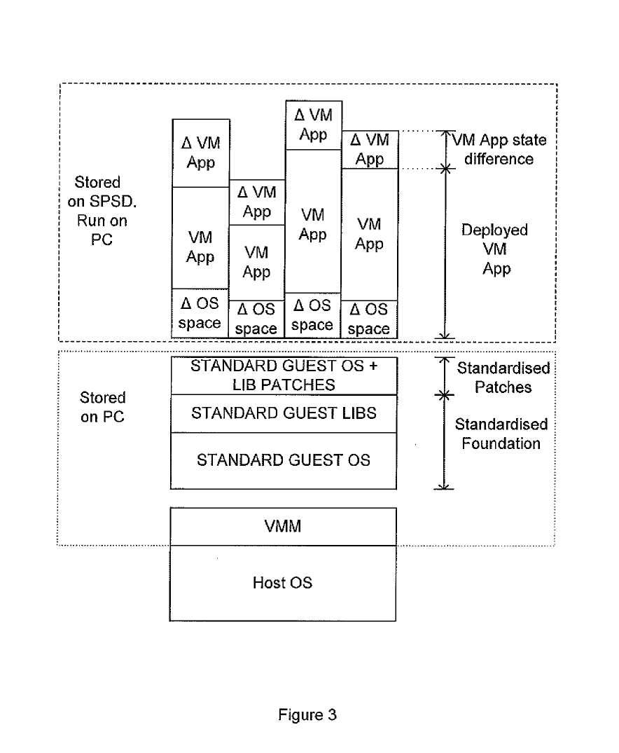

FIG. 3 depicts a Standardised Guest OS and a Standardised set of Libraries that are run on a Virtual Machine Monitor (hypervisor) on top of a Host OS (or bare metal).

On top of these is a layer of (live) patches that modify the memory regions and file-system state of the Standardised Guest OS and Libraries, in order to fix any bugs or vulnerabilities, or to improve its features. Unlike regular patches that may modify the file-system-state only, these patches modify the instruction and data memory in a live manner, and include version information on the patches being used. On top of this, in separate virtual machines, reside a number of Virtual Machine Applications, along with their corresponding modifications to memory in both user-space and kernel space (depicted by the delta in OS space). The changes in the kernel space are depicted as copy-on-write deltas to the standardised foundation memory image below it.

By utilising a standardised foundation image, there are a number of advantages that are conferred:
1. The memory contents for the OS, and the file-system contents for the OS, do not need to be transferred across from the USB device. These can reside on the Host's local storage, or preferably even in the Host's memory. This saves transfer times, and allows reduced bring-up latency.
2. By standardising the foundation image, it supports application-level virtualisation, whereby the resources taken up by the OS (memory and file-system contents) are fixed and common, and each application can reside in its own Virtual Machine (VM) thus providing greater isolation, without greatly increasing the footprint of each application. Otherwise, if each application had a non-common OS, it results in multiple OS instances in memory, taking up precious resources.
3. This isolation of applications into each VM improves its predictability (as it has simpler interactions with the OS). This means that one can better predict the memory pages that are likely to be read or written to, on a per-application basis. The improved predictability can result in reduced bring-up latency by using particular prioritisation techniques.
4. The isolation of applications, also allows applications to be brought up individually, rather than restoring the memory-space/state of an entire desktop full of applications, all at once. This can greatly reduce the amount of data to be transferred, and thus further improves the ‘bring-up latency’ of applications (say from the front-most window, to the rear-most window).
5. The isolation of applications, also allows them to be transportable to other computers, and more easily constrained in licensing policies (without affecting other applications), as well as more secure.
6. Many other novel techniques (warp, sharing, moving, backup, synchronisation) can be applied on an application-level.

One should note that workspace and application virtualisation approaches, such as Ceedo, provide virtualisation wrappers around each application, however, they occur at a higher level of the stack, and thus do not allow execution state, per-Application OS and machine device state to be captured, transported and restored. Instead, in their solutions, applications need to be closed and when launching the desktop on another PC, started up again there.

The Standardised foundation OS, Libs and Patches are common, and run on a Virtual Machine Monitor (or Hypervisor) on top of a Host OS (or bare metal). For each application, Copy-On-Write changes of the OS memory-space, and the VM App itself reside in their own Virtualised space;

### Separation of Concerns in Virtual Machine Images

### Memory State (and Device State)

The VMM is a Type II Hypervisor, loaded on top of the Host OS. The VMM loads into memory and virtual device-state a snapshot of a standard Foundation OS memory image, which can also include a standard set of libraries. On top of this, the VMM can also load in standard patches that are applied to the Foundation OS memory image. Together, this comprises the standardised Foundation OS memory image. The data for both the standard Foundation OS memory image and its patches are loaded from the Host PC's own storage (rather than the SPSD). The file(s) or sectors corresponding to these can be read-only and digitally signed for authentication purposes.

The VMM and the Foundation OS memory image, including libraries and patches, can be pre-loaded into memory before attaching a SPSD, or can be loaded into memory after attaching a SPSD. From the SPSD, VM Applications are loaded into memory, into separate Virtual Machines (indicated by separate columns in FIG. 3). Note that a VM Application can itself contain multiple other interdependent and independent applications. Although such Virtual Machines have a common portion they still maintain their own separate view of memory. Indeed, as each have their own copy of the guest OS running underneath them, memory pages corresponding to the guest OS can change in state. Some of these changed OS memory pages are represented by the “Δ OS Space” in each column of the figure. Loading the application into memory also results in changes to other memory pages, which are represented by the “VM App” in each column of the figure. Indeed, as part of deployment of the Virtual Machine Application, the “Δ OS Space” and “VM App” can together describe the set of memory changes on top of the Foundation OS memory image, of an initial running state of the application. The file(s) or sectors on the SPSD that contain these sets of changes can be read-only and digitally signed for authentication purposes.

As the application is being run, further changes to memory can take place compared to the initial running state. These changes in memory state can occur both in the application's memory space and in the OS space. These changes are denoted by the “Δ VM App” layer. Changes in the “Δ VM App” portion of the stack, that are made during the execution of the application, can be reflected/copied back to the SPSD, either on a continuous basis, a check-pointed basis, or upon closing the application. Note that the same memory page can change many times over an interval of time. Rather than writing out each and every change as it happens, it is more efficient to merge these changes together into a potentially smaller set of writes that is consistent with the memory model. Naturally the file(s) or sectors corresponding to these changes are both readable and writeable. They can also be digitally signed and/or encrypted for authentication and security purposes.

What this means is that the Virtual Machine state can be separated into three main parts as follows:
1. Standard Foundation OS memory image, including libraries and patches—these are read-only, can be signed by the trusted Foundation OS maintainer, data stored on non-portable storage of Host.
2. VM Application in its Initial State (plus any patches)—these are read-only, can be signed by the application licensor, data stored on SPSD
3. Changes in VM Application state since Initial State—these are read-write, not necessarily signed (but optionally could be signed by the user and/or the host machine), data stored on SPSD

Signing of the “Δ VM App” by the host-machine can improve security preventing cases where an untrusted machine or user loads malicious code into the virtual machine. If the VMM checks to ensure that only a trusted machine and/or user has signed these changes before it allows use of them, it can help prevent potential malicious attacks. However, the isolation due to Virtualisation itself is another measure that helps prevent malicious attacks.

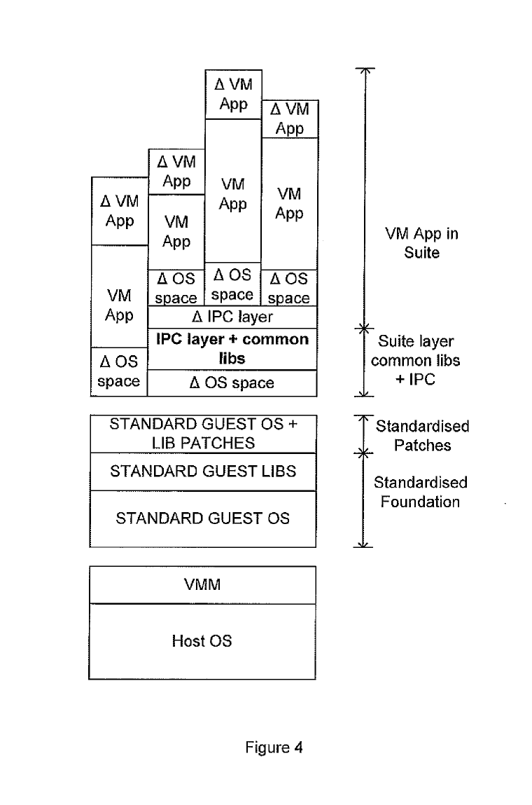

For a suite of applications, such as a productivity office suite, the entire set of applications can be installed as part of a single VM App. However, it can be desirable to rapidly load and save the state of individual applications within the suite, without necessarily loading in the entire suite. For this purpose, each application can be put into its own separate VM App, running in its own Virtual Machine environment. To facilitate sharing and communication between the applications within the suite, however, an IPC layer beneath it can be utilised, which consists of shared memory pages. Ordinarily, memory pages are shared in a copy-on-write scheme, whereby any writes to the shared memory page by the Virtual Machine, result in a copy first being created, the Virtual Machine then having its private copied page mapped into its memory, instead of the original shared page, and the writes directed to this private copy instead. For the IPC layer, API calls and memory writes within the IPC layer occur in memory page(s) that are shared between the suite applications in a read-write fashion, instead of a copy-on-write fashion. This is illustrated in FIG. 4. FIG. 4 shows that in the case of an application suite, there can be a common parent layer (shown in bold) containing common libraries and for IPC (inter-process communication) processes that allow communication between children applications in the suite.

To further minimize memory footprint, the memory allocation routines in the guest OS can be modified so that freed memory is reported back to the VMM as unneeded and can be reclaimed by the host OS. Furthermore, the memory allocation routines in the guest OS can be made more predictable by allocating guest memory regions according to VM application properties, such as the instruction address or stack trace of the VM application at the time of the memory allocation request. The VMM or guest OS may further profile the accesses made to guest memory pages so as to estimate their future probability of usage, and the degree of correlation in accesses between memory pages. These statistics can be stored on the SPSD for later use by the SPSD to VMM transfer manager.

### File-System State

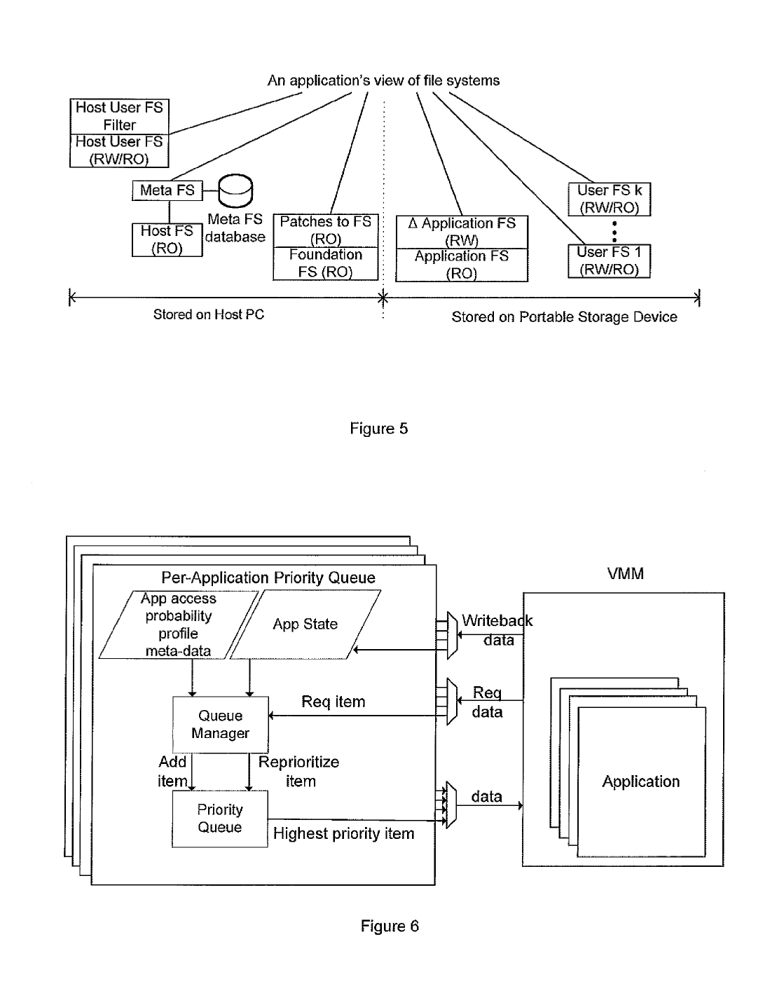

FIG. 5 shows an application's view of file-systems for a single VM. Here, the acronym FS denotes File-System, RO denotes read-only access, RW denotes both read and write access. A number of file-systems can be available to the VM application though effectively mounting them into its base file-system space. Note that two different VM applications can have different views of the file-systems and visible/accessible files within each FS. The Foundation OS file system is always mounted, and has OS files and libraries, on top of which can reside patches to the file-system that can replace or patch these Foundation OS and library files. Both the Foundation FS and the patches to the Foundation FS are read-only, and are signed by the Foundation OS maintainer. Note that two different VM Applications can see different patches on top of the underlying Foundation FS. A meta-file system is also mounted—the concept of a meta-file system is described in more detail later on. The MFS provides a bridge to files in the underlying Host's FS in a portable, consistent manner. The MFS database is consulted to determine the location of desired files in the underlying Host's file-system, which can then be accessed by the Guest VM in a read-only fashion. Such files can include content such as fonts, software libraries or licensed content. In order to ensure the VM Application has limited access to open and edit files, such as on the USB stick plugged into the Host, or other files that reside in the Host FS(s), there is a filtered version of the Host FS(s) mounted as well, filtered subject to the permissions and policy constraints allowed by the Host (and configured in the Host VMM).

The files that are part of and come with the application itself are located in the application's file-space. This consists of two layers, the bottom comprising a read-only layer with these files in their original install state, and the top comprising any modifications made to this read-only layer. This layered approach allows recovery of the application to its original install state by resetting/discarding the layer of changes (likewise for changes to the VM App memory). A number of user-file-systems can also be mounted (here denoted by User FS 1, . . . User FS k), subject to the access policies of the application, the user, the file-system, and the allowed permissions for the host machine. These user file-systems can be unencrypted or encrypted, and are accessed from and stored on the SPSD itself. They can include documents, presentations, images, music, video, specific configuration information and other user data. An example usage of such multiple file-systems, is an unencrypted private FS that the user has for personal files, an encrypted corporate FS for business, and another encrypted client FS for separating out a client's files. Some of these user filespaces can be encrypted and restricted, so that they can only be accessible by particular trusted VM Applications whilst running on trusted hosts, and not on untrusted hosts. In order to allow access to these file-systems, the user can also be required to type in a pin number or password on the SPSD device, or alternatively on the Host as part of the VMM session. This can occur through a request from the VMM to the SPSD for access to particular, protected file-systems, or even protected VM applications. A challenge-response can be exchanged between the Host and SPSD to authenticate the host machine and/or user to the SPSD and visa-versa. A pin-number or password entry request can appear on the display of the SPSD, and the user can enter a valid pin number or password in order for access to be approved.

The Foundation Image file-system, however, can also come with some basic standard applications, such a calculator, basic text editor, terminal, etc. . . . much like modern operating systems also come deployed with some basic standard applications. These basic applications do not necessarily come with a memory image, but are instead loaded into a virtual machine container as needed.

The desktop look and feel of a portable computing environment and other similar settings can be imported from a non-portable computing environment (e.g. from user's personal computer). The process of importing these settings can be done upon initialisation of the user's portable computing environment. This process involves iterating through all settings of the host OS in the computing machine (i.e. user's personal computer), identifying the modified settings and performing the corresponding changes to the guest OS.

Typically, portable computing environments are executed across a number of different physical computing machines. These computing machines are likely to have different hardware devices such as number of displays, display size, special keyboard keys, number of mouse buttons, etc. It would be convenient for users to take advantage of these differences in hardware devices, whenever possible. In one example, the portable computing environment would automatically adjust its display resolution, window sizes and window layout whenever connected to a physical computing machine in order to be optimally viewed in that machine. The VMM would save these user preferences and use them the next time the same portable computing machine is executed. In another example, a physical computing machine may be connected to a printer, which would be accessible to the guest OS through a generic virtual printer device (e.g. PostScript-based printer), as part of its VM. The VMM would serve as an interface between the VM printer and the physical printer that is accessible through the host OS.

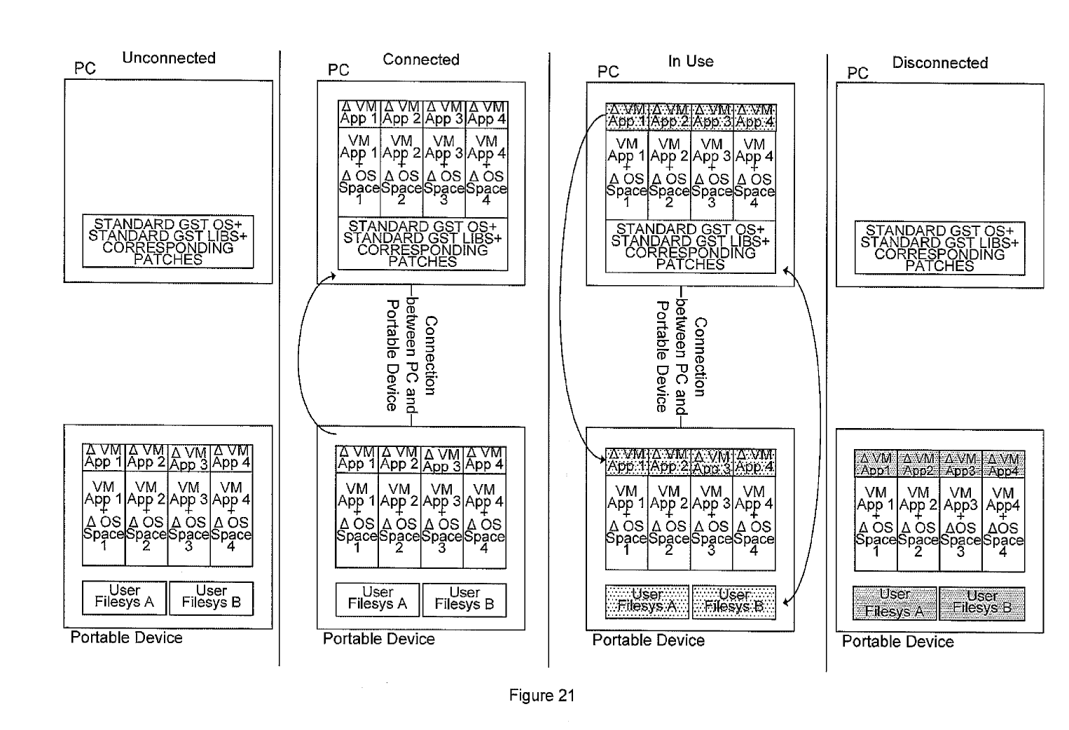

FIG. 21 illustrates an example of Portable-Mode operation, with a PC and a Portable Storage Device. At first the Portable Storage Device and the PC are in an “Unconnected” mode, thereafter they are in a “Connected” mode, thereafter the transferable computing environment is in an “In Use” mode, and thereafter the Portable Storage Device and the PC are in a “Disconnected” mode. At the “Unconnected” mode, the PC already has a standard foundation image (and patches) which includes a standardised guest OS, standardised guest libraries and corresponding patches that comprises a common deployment. The Portable Storage Device has one or more VM Applications (plus OS difference data for those applications), and VM application difference data (including further OS difference data). There are also one or more user file-systems stored on the device. Upon connecting the Portable Storage Device to the PC, the system transitions to the “Connected” mode. At the Connected mode, parts of the VM Applications (plus OS difference data for those applications) and VM application difference data stored on the Portable Storage Device are transferred to the PC so that, together with the standard foundation image (and patches) the VM Applications can each start to execute on the PC in their own Virtual Machines. At this point, the system transitions to the “In Use” mode, where as each Virtual Machine is running, the memory state (including execution state and device state) of the Virtual Machine starts to change, and the file state specific to the VM Application can change. As the VM Applications (plus OS difference data for those applications) are fixed during usage on the PC, such changes are isolated to the VM application difference data (denoted as changed by the grey boxes). These changes are copied across to the Portable Storage Device into their corresponding VM application difference data portions (the changed VM application difference data denoted by these boxes going grey). Furthermore, the contents of user file-systems on the Portable Storage Device can be read, written and modified by the VM Applications running on the PC (the changed file-systems also denoted by grey boxes). In the “In Use” mode, further parts of the VM Applications (plus OS difference data for those applications) and VM application difference data stored on the Portable Storage Device can be transferred to the PC as needed for execution of the Virtual Machines. At some point the PC and Portable Storage Device can be disconnected from each other at which point the system transitions to the “Disconnected mode”. At this point any inconsistent pending changes being made to the combined VM application difference data and user file-systems on the Portable Storage Device can be discarded by the Portable Storage Device. The Portable Storage Device is then ready to connect to another PC (or even the same PC). It should be noted that while the Portable Storage Device is not connected to a PC, native apps running on the Portable Storage Device can still be used on the Portable Storage Device that can access and modify the file-systems and VM application properties.

### The SPSD to VMM Transfer Manager (on SPSD)

The SPSD and VMM on the PC are connected by some communication link (such as USB, WiFi, Bluetooth, etc). A transfer manager, preferably located on the SPSD device, manages the transfer of metadata, window images, memory pages, files and other data by way of one or more priority queues. There can be a priority queue per application or a combined priority queue for all applications. Items demanded by the VMM can be given the highest priority within a priority queue, in the order that requests are made.

At a higher level, there can be a priority of applications, with applications at the front of the desktop given priority ahead of applications at the back of the desktop (in window order). Within an application, in one instantiation—the highest priority transfer on first connection to the VMM can be the bitmap image of the application windows. Thereafter a prioritised queue of most probable memory pages is transferred. Any requests from the application guest OS, is either added at the head of the queue (if it's not already in the queue), or is reprioritised to the highest priority of the queue (if it is already in the queue), but in order of request. Writes to memory are saved in order, according to a checkpoint of state. A new checkpoint is first opened on the storage device, and then all memory writes to affected pages are saved, before closing the checkpoint. Only when a checkpoint has closed are the writes allowed to properly merge with the VM state on the storage device (however multiple such checkpoints can be combined before merging with the VM state on the non-volatile storage of the device). Upon disconnecting the storage device, a still open checkpoint can be discarded as having inconsistent state. The merging of checkpoints can be performed by the mobile storage system itself, or the host machine VMM.

The transfer and/or the storage of data can occur in a compressed manner, such as with RLE (Run-Length Encoding), or other approaches.

FIG. 6 shows the transfer of data mediated by a priority queue. This includes the case where the priority queue only stores tags corresponding to portions of state data, and the state data corresponding to the tag is fetched on demand from the application's state data (App State) held in non-volatile memory. At startup, the priority queue is initialised with entries according to the access probability profile meta-data. This meta-data can be calculated on-line or off-line—one approach is to track consecutive requests and correlations between page accesses to update estimated probabilities of memory pages, another approach constructs the meta-data once statically for inclusion with the application on deployment, another approach combines these two.

As new requests come in, the Queue Manager determines the priority of the item. If the item is already in the priority queue, then it is reprioritised, otherwise it is added to the priority queue. The Queue Manager can consult the meta-data to recalculate the priorities of other items, consequently it can insert or reprioritise further items in the Priority Queue. The output from each Application Priority Queue is multiplexed to the VMM. The data item chosen by multiplexing is based on reweighing the priority of the data according to the current priority of the Application. One such mechanism is to simply multiply the priority of the data item with the current priority of the application, and then selecting the highest weighted priority. The requests and writebacks themselves are demultiplexed unconditionally.

Note that the Queue Manager and Priority Queue should preferably reside on the smart mobile storage device itself, but can alternatively instead reside on the host machine, including as part of the VMM. However the App State resides on the smart mobile storage device itself. (Note that if the transfer manager resides inside the VMM on the Host then request demultiplexing is not necessary, however writeback and data prioritisation is still needed).

### Continuous Saving of VM Application State

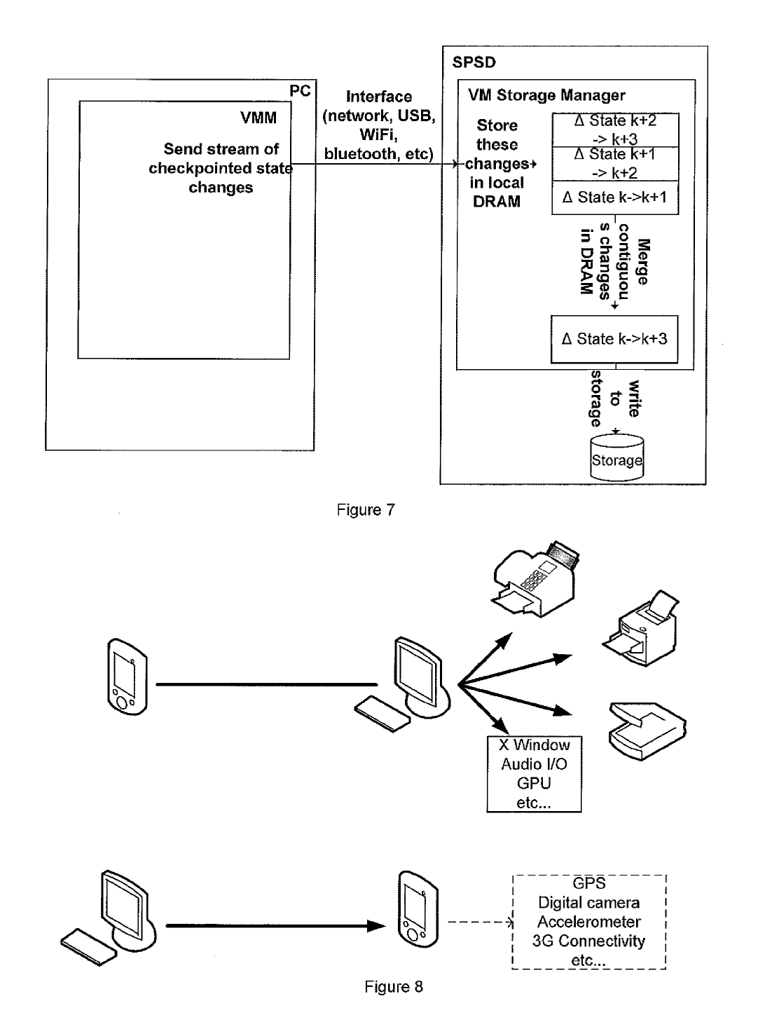

Ideally, one would like to be able to immediately disconnect and leave the PC, such as merely taking the SPSD and running off with it. To facilitate this, changes in the Virtual Machine memory and device state are continuously reflected/copied and checkpointed to the SPSD. As user files are hosted from the SPSD itself, their contents do not need to be backed up on the device, however their state is checkpointed consistently with memory/device state checkpoints as well. The SPSD can merge checkpoints together in its DRAM or other low-power memory before writing it to non-volatile (flash) memory. This reduces power-consumption and increases the life of non-volatile memory by reducing the number of write-cycles. This is illustrated in FIG. 7. FIG. 7 shows transfer of Application state from the VMM on the PC to the SPSDs permanent storage (flash) via interface and after merging in non-permanent memory on SPSD device.

### Desktop Backup

The user can nominate one or more trusted PCs that can backup their portable computing environment. Whenever they connect to such a machine, the change in state from the storage device can be transferred partially or in its entirety to the machine. Moreover, the continuous saving of VM Application state can be reflected in the PC's accessible storage as well. This storage can, in turn, be remote such as over a SAN or NAS.

The backup can be restricted according to resource policy controls. For example, a policy control can restrict company resources on the SPSD from being backed up on a non-corporate PC. Alternatively, the resource policy can state that backup for that resource can only occur over a VPN network to the company's private servers.

### Application-Level Back-Stepping

This involves instantly restoring the VM App state to a previous instance, such as a minute earlier. A restore checkpoint can be made every minute, and only the last few checkpoints retained. Back-stepping then involves discarding the change in state since the restore point, and restoring any changes made up to that restore point. One approach is to save an ‘undo’ state that stores only those values from the time of the restore point that have been modified since the restore point. Another approach involves a command requesting that changes since the restore point be discarded, and then for the VM App to be reloaded with that restore point.

### Sharing Between the SPSD and PC

### Shared File System Manager (SFSM)

The SFSM maintains integrity, security and policies for the file systems stores on the SPSD.

The SFSM manages access to file systems shared by both Apps running on the SPSD and Applications running on the VMM. All file operations (including read, write, delete, create, rename, etc. . . . ) to these file-systems are required to go through the SFSM, which can occur though a shim on the SPSD and the VMM. On the VMM-side, an Application invokes an operation request though the Guest OS, then a corresponding hypervisor call(s) to the VMM, which then passes it through to the SFSM on the SPSD via a connection (e.g. USB, WiFi, Bluetooth, etc).

In terms of integrity—it is possible for an App running on the SPSD and an Application running on the VMM to try to simultaneously access and modify the same file, potentially causing corruption or bad state. The most basic fail-safe mechanism merely has the SFSM refuse to grant write access to a file that already has been granted write access by another App or Application. An App or Application can register an event handler with the SFSM. Suppose App or Application has write access to a file (let us denote this App/Application as alpha), and has registered an SFSM exception handler. Suppose another App or Application requests write access to this file (let us denote this App/Application beta). The SFSM can call the exception handler in alpha, to request that it give up its write-privileges. The App or Application alpha can then decide on whether or not it wishes to do so. If it does not, it returns a decline status from the exception handler, and retains write access to the file, in which case the SFSM declines access to beta. If it accepts, then it can first update the file using its write privileges, before returning an accept status from the exception handler to SFSM, thereby releasing write access to the file. The SFSM can then grant access to beta. When beta releases write privileges to the file (by another call to the SFSM), the SFSM can again call alpha's exception handler to inform it that write-access is available again. Indeed, when alpha releases write-permissions it can potentially indicate whether or not it would like to be informed of the write access being released. In this case, the SFSM can prevent another App/Application (gamma) from borrowing write-privileges from beta, as they should be made available to alpha instead.

In terms of security—one or more of the file systems can be encrypted, and should only be accessible on trusted Host machines, (or even particular trusted apps or applications—see policy). The SFSM can request that a PIN number or password be provided (such as by popping up a request for password input on the SPSD) before providing decrypted access to the file on the Host. Such files are decrypted by the SFSM, however SFSM communication between the SPSD and VMM can be encrypted separately with standard point-to-point encryption schemes. Alternatively, the Host can have its identity authenticated by the SFSM (e.g. using a Trusted Platform Module), and access granted with an encrypted token stored in a protected region on the Host.

In terms of policy—access restrictions can be placed on files, directories or entire file-systems. This can leverage the user, group and other permissions of the available file-system. For example, access can be restricted to apps or applications in the group ‘corporateABC’ for certain files, directories, or even file-systems. The Apps or Applications themselves can be restricted to only run with those permissions.

### Resource Sharing Manager

A Resource Sharing Manager resides on both the SPSD-side and the Host-side (in the VMM). They communicate to each other over the SPSD-to-Host connection, informing the other of the available resources, and providing an API to Apps and Applications for utilising these resources. For example, the SPSD instance can inform the VMM instance of availability of GPS sensors, accelerometers, camera, 3G connectivity or other resources on the SPSD. Similarly, the VMM instance can inform the SPSD instance of printing capabilities, graphical display, GPU, mouse, keyboard, or other resources on the Host, For an example of resource sharing, see FIG. 8.

Sharing access to these resources is subject to Policy controls on the Host OS, the SPSD OS, and the VMM. Policy control within the Resource Sharing Manager can accept or deny requests. Such Policy can consist of following a decision tree of granting or denying access based on Boolean combinations of attribute comparisons such as App identity, Application identity, Host identity, Group membership of App or Application, resource type, resource ID. A decision tree can be configured per-resource.

On the host-side, possible shared resources can also include audio, overlay video and to an X-windows type interactive display (such as creating a new X-session). This allows an App running on the SPSD to setup a window session on the Host side on the VMM Desktop.

On the SPSD-side, possible shared resources can also include VPN access via the 3G network, or over its WiFi network.

The connection between the SPSD and Host can be established over a network, such as using the UDP or a TCP/IP protocol, or via protocols such as Bluetooth, USB and others. A connection manager on both the SPSD and Host side can manage the flow of messages exchanged between them.

After connection of a link between the SPSD and Host, the Host-side Resource Sharing Manager and the SPSD-side Resource Sharing Manager can exchange one or more lists of resources accessible on their side that can be made available to the other side. Each resource has a standardised unique resource identifier which, for example, could be a string or a number. While a list can be exchanged in a published push-model, it could also be exchanged in a pull-model, whereby one of the SPSD or Host side must explicitly ask whether or not a resource is present and the other side can respond as to whether or not it is present and accessible. An app on the SPSD can then request, using the Resource Sharing Manager, for details further describing the attributes of a particular Host resource. Similarly a VM Application on the Host can request further details of a particular resource on the SPSD. An SPSD app or VM application on either side can then request permission to access the resource, which the other side may grant or deny based on security policies and/or license permissions. If granted, an access token can be sent back to the requesting SPSD app or VM Application that can be used for authentication of further command requests concerning that resource. The Resource Sharing Manager on the recipient-side can then check for a valid token for that resource, before allowing a corresponding command to be issued to that resource. Inter-device commands to shared resources can take the form of standardised numeric identifiers followed by arguments and data, over the network link. For example, a command can take the form of a combination of a requester ID, a requester token, a resource ID, a command ID, a data-length field and data for arguments corresponding to that command. The Host-side and SPSD-side resource managers can have a standardised transformation and/or translation between API function calls and the corresponding command ID and data fields of inter-device commands.

Computational resources on the host-side could also be made available to SPSD apps. For example, computation-acceleration resources on the host-side, such as a GPU, could be accessible via corresponding translated and/or transformed function calls on the SPSD-side. An SPSD app could directly leverage these Host resources by function calls to the Resource Sharing Manager on the SPSD. Alternatively the SPSD app could make function calls to a modified OpenCL library loaded in the SPSD, that transforms and/or translates them into function calls for the Resource Sharing Manager on the SPSD. The function calls to the SPSD-side Resource Sharing Manager can then result in corresponding commands issued to the Host-side Resource Sharing manager over the SPSD to Host connection. The Host-side Resource Sharing Manager can then transform and/or translate these commands into corresponding API calls, including OpenCL calls, on the Host, the responses for which are transformed and/or translated into corresponding responses back to the SPSD. These responses are then transformed/and or translated by the SPSD-side Resource Sharing Manager to the caller of the function, or to a message/exception handler. This can allow an SPSD app to be accelerated by leveraging the shared GPU resources from the host.

### Paired-Applications and Paired-Application Coherence Manager (PACM)

An Application that executes on the VMM and an equivalent App that executes on the SPSD can be paired together to form a Paired Application. Such a Paired Application can be bundled together for installation or deployment. An example of such applications can be a document editing paired-application, or an audio manipulation paired-application, or a calendar or email paired-application. These applications have state (platform independent property data)—for example, a document editing app or application has state concerning what files are open, what websites are open, where the cursor is, how the windows are arranged, what is in the clipboard, and other state. It is desirable for such actions in one of the pair to be mirrored in the other for a seamless experience across them. A Paired-Application Coherence Manager resides on both the SPSD and inside the VMM, and communicate to each other to maintain coherence. Applications running on the Host-side can call an API in their Guest OS, and apps running on the SPSD-side can call an API in their SPSD OS. The APIs on both sides provide function calls to update shared application properties. These properties can consist of an identifier for the property (such as cursor position), followed by the property value—such as the actual cursor position. API calls on the Host-side go through the Guest OS, through a hypercall to the VMM's Paired-Application Coherence Manager which results in an encoded request sent to the SPSD-side Paired-Application Coherence Manager to update properties. API calls on the SPSD side can go directly to the PACM on the SPSD side, and a corresponding encoded request can be forwarded to the PACM on the Host side. The PACM on either-side can identify the originator of the request (based on their stack trace or other properties) and thus encode this information into the request as well for the other PACM. Such updates to application property, from either side, can reside in a database, held in the SPSD memory or file-space or combination thereof, or in two separate queues (one for each side), or in a combined queue. These queues can be held in SPSD memory or SPSD file-space. Note that both application and app do not need to be simultaneously running for state to be reflected. Instead, the updates to application properties from one can be stored and made available to the other app/application when it is resumed/relaunched. Receiving application updates can occur in either a push or pull model. In the push model, the app/application is explicitly notified by the Paired-Application Coherence Manager (this involves the PACM communicating each such update to the other PACM, which then calls the corresponding exception handler in the App/Application). Alternatively, in the pull model, the other App/Application can periodically poll its PACM for outstanding updates. If this occurs on the VMM-side, then the VMM PACM queries the SPSD PACM and relays the result back. It is important to note that the state coherence managed by this API is a separate mechanism to the state “Δ VM App” of FIGS. 3 and 4. The PACM governs specific properties that are explicitly updated by the SPSD App and VM Application which are written or modified to use the PACM API calls within their respective environments, whereas the “Δ VM App” state concerns changes in the memory address space of the VM Application as part of the normal execution of the application(s).

Furthermore, the SPSD App and VM Application can operate simultaneously and in concert, whereby actions performed on one device are relayed to the other device. For example, a photo editing VM Application may integrate via the PACM with the paired SPSD App so that changes made to the picture through one device are reflected in the other. In such an example, the SPSD App could also display a convenient toolbar of buttons that when a button is pressed, relays via the PACM, for a corresponding action to be performed in the VM Application. In such an example, selection of the image window or toolset in the SPSD App could also change the tools and picture preview displayed and selectable on the VM Application, and similarly selections made in the VM Application could affect the options seen in the SPSD App.

### Distribution, Policy and License Enforcement

### Distribution

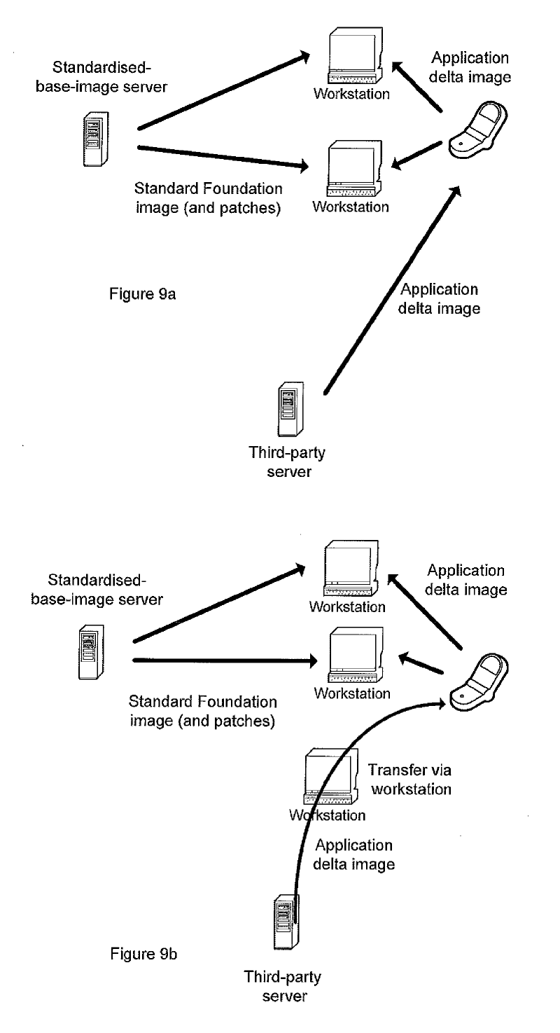

This platform enables a novel approach in distribution. In FIG. 9, the standard foundation image (or the meta-image with which to construct the foundation image) is publicly available from a server and can be installed on demand, or in advance on multiple workstations. This foundation image comprises the file-system and memory and state of the virtual machine as having state X. One or more third-parties can then construct application delta-images. This is done by first loading the foundation image state, and then loading an application into the memory and file-system of the Virtual Machine, thus comprising a new state Y. The differences in state between X and Y are then encoded in a delta-image D. For example, in FIG. 3, the delta-image may comprise of both the “Δ OS Space” and “VM App” components. This delta-image is sent by one or more third-parties either directly to the mobile storage device (as in FIG. 9a) or can be transferred via the storage/network of another workstation (as in FIG. 9b) to the mobile storage device. When connecting the mobile storage device to workstations, parts or all of the delta-image can then be transferred to the workstation, which together with the publicly available foundation-image state X, allows for restoration of the entire running application (Y=X+D).

Furthermore, a live patch P can be made publicly available for the standard foundation image, which can fix any bugs, security vulnerabilities, or add features to the standard foundation image. In this situation, the combined state X+P+D would then comprise a state of the entire running VM including the application. The specific patches can even be applied on a per-application basis, using a compatibility profile either included with the application delta-image, or that can be probed from a third-party server. This means one application can run on a different patch version to another application (i.e. X+P1+D1 vs X+P2+D2). Applications, themselves, can also have live patches Q thus resulting in X+P+D+Q.

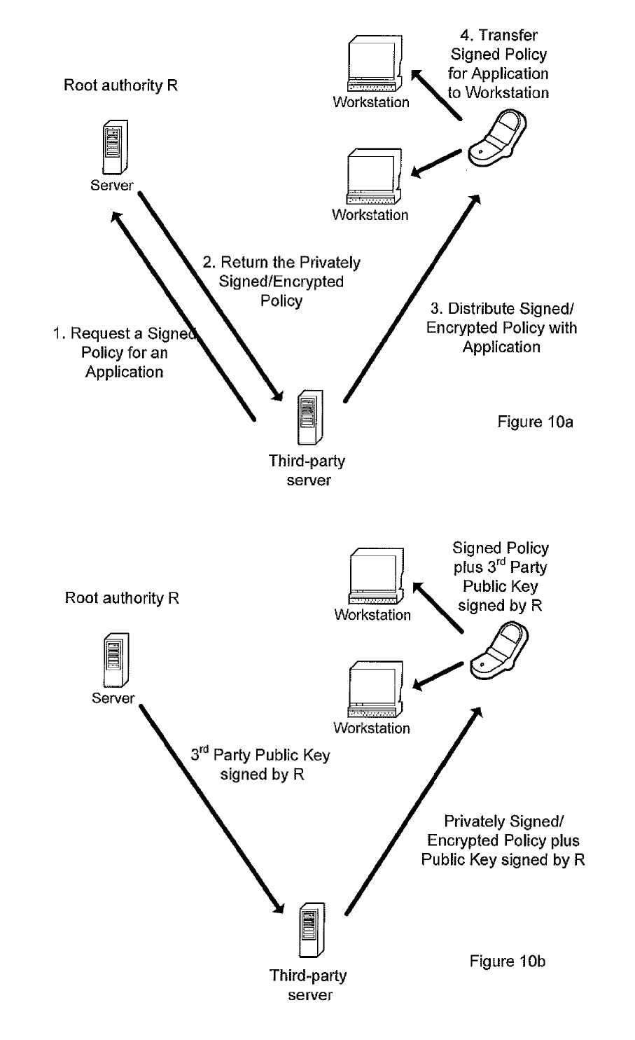

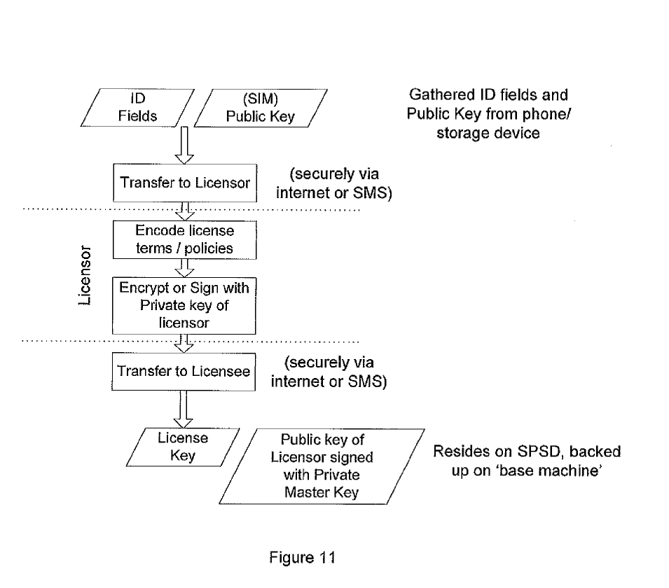

Each application has only limited access to resources, as per the Access Policy. The Access Policy can be distributed along with the Application delta-image, and consists of a signed or encrypted policy statement, and optionally, encrypted portions of the Application delta-image as well. For an Access Policy to be accepted on the workstation VMM, it is authenticated/decrypted with a valid public key. There are two main cases for how this works as illustrated in FIG. 10. The first is a centralised model (FIG. 10a), whereby only keys from a single central authority are valid. In this case the third-party submits their Access Policy (and optionally the portions of their Application delta-image) for encryption/signing by the Root authority R. That authority can then return with an encrypted/signed Access Policy for the third-party to then distribute along with their Application delta-image. In the decentralised model (FIG. 10b), other public keys are accepted as valid, provided those keys have been signed by the Root authority R. In this model, the Root authority R distributes a signed public key to the third-party, which can then construct their own Access Policy to distribute with their Application delta-image, along with their signed public key. An addition to this is that instead of distributing only a signed public key, the Root authority can encode both the public key and an Access-Policy Limitation (also denoted as Allowable Access Policy Permissions in FIG. 15), which are then signed together, and are distributed together. The Access-Policy Limitation can comprise a mask of allowable privileges that the third-party Access Policy is allowed to grant, and conditions for the expiry, name, author and size of the Application delta-image. The VMM enforces both the Access-Policy and the Access-Policy Limitation. In this way, the Root authority R can restrict the Access-Policy granting privileges of third-parties and do so on a per-application, per-company, or other basis. These keys can also be revoked automatically by the VMM on the workstation whereby it periodically checks with a central authority to determine if a key should be revoked.

Note that an application, running in a single guest OS on top of the foundation image, can actually include a suite of sub-applications and an environment for launching, manipulating and closing such sub-applications.

For effective live-patches to the foundation image (OS and libraries) resident in memory, portions of the Guest OS address space can be reserved in advance for this purpose that are not available for ordinary use by the OS/libraries or guest OS applications. Portions of the address space can also be reserved in advance for live-patches to the guest OS application as well.

### License Management

Each application includes a policy, and can require a license associated with the application. There are two components to this approach:

Access Permissions: (policies) these are the policies that grant permission for an application to access files, network, or other resources. By default, applications have the lowest set of access permissions, allowing very little in the way of network or other access by the Host VM. Isolation of applications in VMs allows this form of per-application restriction for security. Such access permissions can include general network access, particular VPN access, USB device access on the host, access to protected file-systems, access to cameras on both the host and the SPSD, and connectivity access to a paired-application on the phone.

Usage Restrictions: (licenses) these restrict an application from running without the proper license. A license manager running on the SPSD, or in the cloud, grants access to the application to run.

These two components can be distributed separately, for example the policy could come with the application itself whereas the license could be available only after purchase, or alternatively they can be distributed together. Furthermore, they could be linked together, so that if the license is revoked, the policy is also revoked.

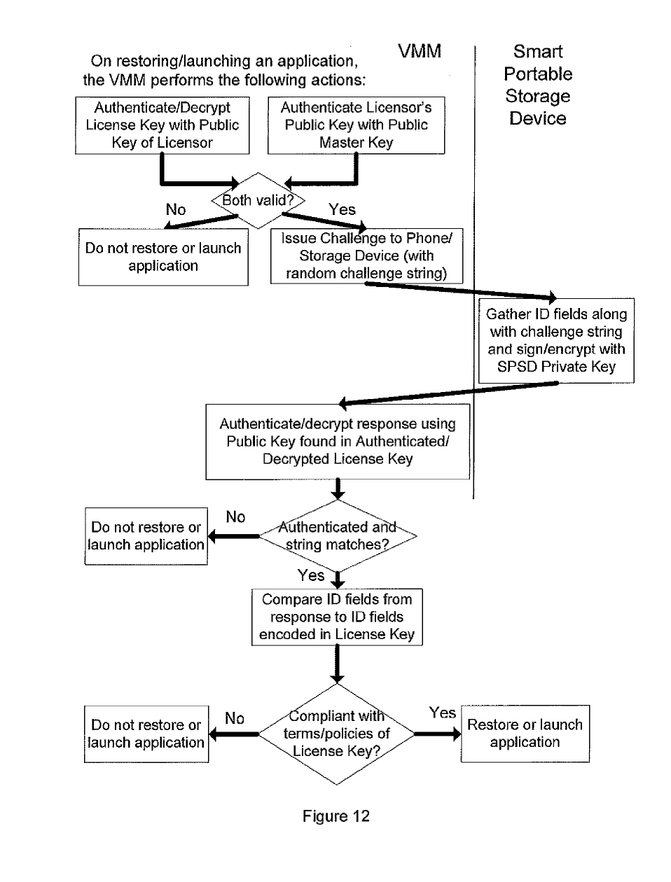

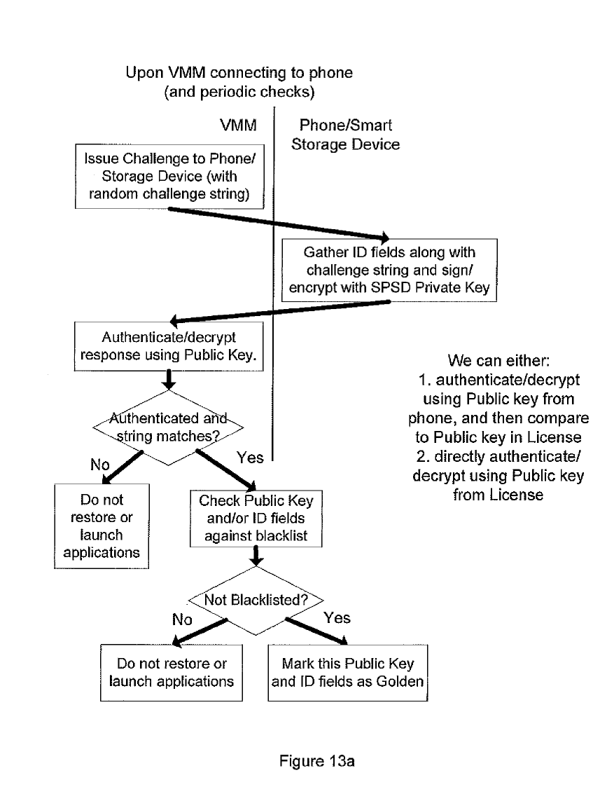

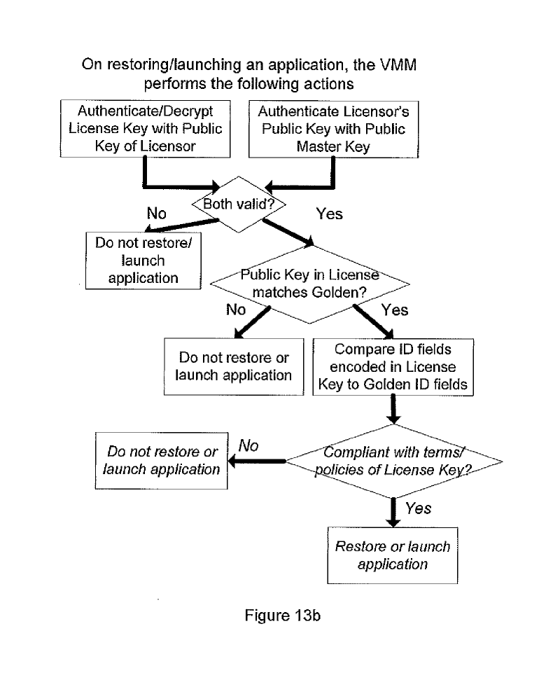

In FIG. 8, we see one approach of license checking and validation before application restore or launch. When a restore or launch is requested, the VMM checks for the application license. It verifies the authenticity of the license using a Public Key of the Licensor and also verifies the authenticity of this Public Key, by using the Master Public Key. If this verification is successful, the VMM next checks for the presence of the SPSD that is bound to this license. It does so by issuing a random string challenge to the SPSD. The response message of the SPSD consists of the challenge string as well as the ID fields (detailed below under Usage Restrictions) and is signed/encrypted with a private key within the SPSD (e.g. SIM private key). When receiving the response from the SPSD, the VMM verifies the authenticity of this message using the public key of the SPSD (e.g. SIM public key). This key is found in the authenticated License Key. If the message is successfully authenticated, the ID fields from the message response are compared to the ID fields encoded in the license key. The application is not restored/launched unless the ID fields in the license match with the ID fields that are sent as part of the SPSD response. At this stage, it is also clear what the access permissions and usage restrictions of the license are, and the application is not restored/launched unless it is compliant with the terms and policies of the license. Note that the decisions in FIGS. 12, 13a and 13b need to all be ‘Yes’ for the application to be launched or restored, but can be performed in other orders or in parallel.

### Access Permissions

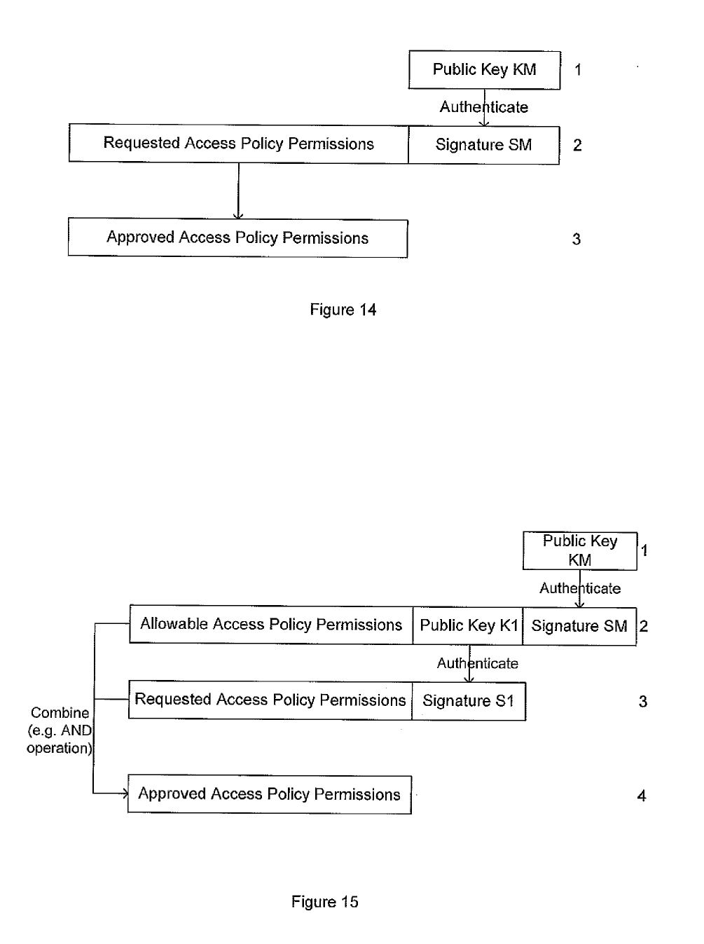

For Access Permissions, the permissions can be digitally signed or encrypted, along with the executable code/image of the application VM. Then a VMM loading it can decrypt and check for the permissions, and only run it with those privileges. A direct authentication model is shown in FIG. 14. Here the signing/encryption is done with a large private key that is only known to the master authority, which can be authenticated/decrypted by the VMM using the public key of the Master authority (KM). Upon authentication, the access policy is approved. In the third-party authentication model (see FIG. 15), a third party licensor policy is distributed along with the application, which contains a policy of what permissions the licensor is allowed to grant as well as a public key for authenticating policies created by the licensor (this is item 2 in the figure). These licensor permissions are signed/encrypted by the master licensor. The public key of the master licensor is then used to authenticate these permissions and the public key of the licensor. The requested policy permissions of the application are distributed along with the application, and are signed/encrypted by the private key of the licensor. The VMM can then authenticate the policy request, then restrict it to be compliant with the licensor's approved policy granting permissions to form the application's access policy constraints.

In both these models, concatenated to the policy can be MD5 checksums of the application or its components to validate the integrity of the application (item 2 in FIG. 14, and item 3 in FIG. 15). Concatenated to the application policy can also be critical portions of executable code (and their location in memory), that are removed from the application, but need to be present for correct operation of the application.

### Usage Restrictions

For Usage Restrictions, the license is fetched from the SPSD and/or cloud, and can be verified at two levels—from inside the guest OS or application and from the VMM. The guest OS application can request the license key, via the VMM, and alternatively, the VMM can request the license on the guest's behalf. If running and no license has been secured, the VMM can inform the guest OS application that its license has been revoked.

In FIG. 11 a license is generated by taking ID fields from the SPSD, such as Phone number, (SIM or other) ID number, and other specific information about the phone and user, such as the telecom provider and the user's full name. This is sent along with the SPSD Public key to the Licensor party, securely via the Internet, or by the telecom/SMS network. The Licensor party then encodes the usage restriction terms, expiry and renewal policy to this information (typically by concatenating each of these fields). This information is encrypted or signed by a private key held by the Licensor party. This constitutes a License Key for the user. This License Key is then securely transferred back and stored on the user's SPSD storage. This can be via the Host machine's Internet, or directly by the telecom network. The signed Public key of the Licensor can also be transferred to the host computer or SPSD if it is not already present.

In FIG. 13 we see one approach as to how the license key is validated and corresponding license terms/policy enforced. Identifiers associated with the SPSD are first requested and authenticated. In FIG. 13a the VMM on the Host issues a challenge to the attached SPSD device. This challenge consists of a random string (nonce). A PKI (Public Key Infrastructure) unit on the SPSD, can reside on the SIM card, a smartcard, cryptographic hardware on the SPSD itself, or as software installed on the SPSD. There is a public-key and private key that is associated with the SPSD PKI unit that we henceforth refer to as the SPSD public-key and SPSD private-key respectively. For example, these might be stored in a SIM card that has a PKI module. The PKI on the SPSD device encrypts/signs the random string along with ID fields such as the SPSD number, user's name, SIM card identifiers, telecom provider, and other details using the SPSD private key. This, along with the SPSD Public Key, comprises a response that is returned back to the VMM on the Host. The VMM then authenticates/decrypts the response using the SPSD Public key. The VMM tests to see if the response is valid. If it passes, the SPSD Public Key and associated ID fields are marked as golden. If not, then the VMM refuses to launch any applications. This challenge/response and process of validating the golden SPSD Public Key and ID fields only needs to happen when the SPSD is connected to the VMM, or first launching apps from the VMM. However, it can also happen periodically (say every few minutes) to ensure that the SPSD is still connected.

In FIG. 13b, each VM application has its license key authenticated/decrypted by the Public Key of the Licensor. This Public key of Licensor is also authenticated using the Public Master Key for the VMM (held by the Master authority). The SPSD Public Key encoded in the App's License Key is compared to ensure that it also matches the Golden License Key found in the earlier challenge step (FIG. 13a). The ID fields from the App's License Key are also checked against the Golden ID fields according to the License Key's policy/terms. If all these conditions are complied with, then the VM App is allowed to run, otherwise the application remains suspended.

### License Revocation

In one approach, tokens for licenses are time-limited—a token that has a start time and end time is automatically obtained by the VMM, via the internet, from the licensor company, the token having been signed by the licensor company's private key. The VMM prevents execution without a valid signed license token and checks that the current time is within the valid period of the token. Before the expiry of the token, the VMM can automatically try to obtain another token from the licensor.

In another approach, at a regular interval from when the application license was created, the VMM can check with the licensor that the license key is valid. It can do so by sending information about the license key, such as its MD-5 checksum to the licensor, via the Internet, and if it finds that it is not valid, the VMM can add this license to its local list of invalid licenses, and to the list of invalid licenses located on SPSD/SIM storage.

### Transferring Licenses to New SPSD

The reissuing of licenses can be requested from the user for a new SPSD. If the new SPSD is a mobile phone and they have kept their phone number, then the request can be made by an application on the phone, or on the PC. The request can be sent in two ways:

### 1. Direct Request to Licensor

In this form, a request is made to the licensor servers, and an SMS token string is sent back to the registered phone number. If the SPSD is a phone, an application on the SPSD can directly handle the token, and then send it back to the licensor server as authentication. Alternatively an application on the PC can request the user to enter this token string, and this can send it back to the licensor server as authentication. This utilises the phone-network to authenticate the user before issuing replacement licenses. Further forms of personal identification can also be requested. After successful authentication, the old licenses are revoked (as above) and new licenses are issued (as described earlier).

### 2. Indirect Request via Multi-party Licensor Manager.

In this approach, authentication is performed by one party, who then securely requests transfer of licenses on the user's behalf from other licensors.

Once authenticated, all the user's application state, files and data on their primary nominated PC can be restored to the new SPSD.

### Lost Phones/SPSDs

In the event of lost phone SPSDs, both the SIM card and the phone number could change. At the user's initial license registration, the user can provide the phone number of a trusted person (or persons). The same process of transferring to a new SPSD can be followed as above, but in this case the authentication token string is sent by SMS to the trusted person's phone instead.

### Guarding Against Man in the Middle Attack

One danger is that multiple users can try to use the same license. To guard against this, at a deterministic interval from when the application license was created, the VMM can check with the licensor that the license key is valid. If multiple requests are made to the licensor from different IP addresses, at a duration (say of ten minutes) around one interval point, then the licensor can invalidate the license, starting from the second or later requests.

### Selective Remote Kill

A special, signed message can be sent to the SPSD, such as in the form of an SMS, which a module on the SPSD can monitor. Depending on the message, and subject to authentication on the SPSD hardware, SIM card or other authentication unit, portions of the stored content can be deleted, including licenses, files/file-systems, SPSD apps, VM applications and VM application state. Each such content resource on the SPSD can be protected by such a remote-kill functionality, with per-resource public keys that can be used to authenticate a kill request. Each resource can be a component in another resource, in a tree-like manner. Thus whole branches of resources can be killed by a suitable message. For example, a company can provide application and file resources that are protected by a remote kill functionality. In this event, any such sensitive content can be killed by the company, whilst leaving the other user data intact.

Multiple incorrect attempts to access the SPSD (such as invalid PIN number tries) can also lead to these resources being killed (deleted).

The kill mechanism can also work over the Internet, where at some interval, or upon connecting to the Internet, the SPSD can check for any kill requests for it, and proceed with authenticating and completing the request.

The same mechanism works for PCs that have been nominated to back up content of the SPSD.

### Application Transfer

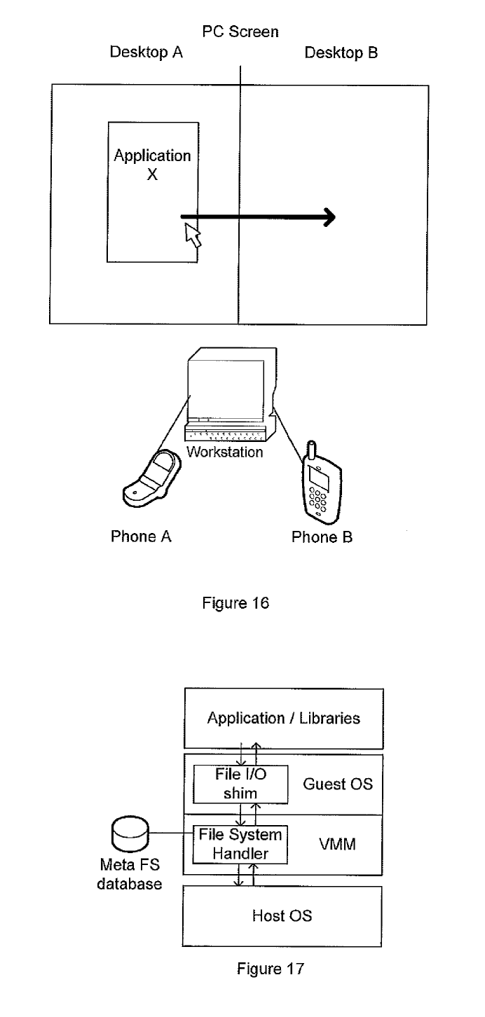

This novel methodology involves transferring a running application from one SPSD to another SPSD (if licenses and policy restrictions permit). Two SPSDs can be connected to the same PC (via USB, Bluetooth, WiFi, etc), or alternatively on different PCs connected to each other either directly or via an intermediary server, and the Application can be transported from one to the other (directly if on the same PC, via the network if on different PCs or via the server if using an intermediary server). This is illustrated in FIG. 16. FIG. 16 shows two SPSDs connected to one PC. Desktops associated with each SPSD are displayed on the PC Screen. An action is illustrated of drag and drop of Application X from Desktop A on SPSD A to Desktop B on SPSD B. This initiates a transfer of Application X from SPSD A to SPSD B; In one instantiation this can involve two virtual desktops displayed on the PC at once, and merely dragging a running application from one virtual desktop to the other. A prompt can then ask to confirm whether or not to move them or copy them. If the action is a copy or move, then the application state information associated with the said Application is copied from SPSD A to SPSD B. If the action is a move, the said associated application state information on SPSD A is also deleted. If any file handles in the user's personal filespace are currently open by the application, the user can also be given the option of moving/copying them as well. Finally, if the application is tied to a license, the option can be given of transferring the license. This can involve contacting the license provider and requesting that it be revoked for the source SPSD, and then reissued for the target SPSD as per License constraints listed earlier.

### File System Handling

### Host File-System Pass-Through and Policy Checking

In order to comply with 3rd party software license restrictions, not all files can be distributed with the application or foundation OS image. However, the Host machine can have a license to use these files and can even have these files already present on its Host-OS file-system. In this case the VMM can pass through file-access requests for such files to corresponding files found on the Host machine. When a VM Application makes such a file-access request, if no such license or licensed file is found, then the file-access request can fail, or VM Application execution can be suspended, depending on the policy terms of the application. Care must also be taken where the memory contents of such files are loaded and in use inside an application guest OS.

Thus there are two components to ensure licensing compliance:
enforcing licensing constraints on files
enforcing licensing constraints on file content loaded into memory pages

License-protected files are addressed by the Meta-File System (MFS) described further below. A benefit of the MFS approach is that this can reduce the number of files that need to be deployed with the application or foundation OS, thus reducing their footprint, as these can instead be found on the Host file-system. (Indeed, all or parts of the foundation file-system can be described by a MFS, describing the file-system structure on the foundation file-system, as well as resolution of the file to files included with the meta file system or referenced by the meta file system on the host file system)

Licensed content that is loaded into memory pages can be tracked by the modified Guest OS by a special hypervisor call that tags these memory pages. This is done by setting up flags denoting license-protected pages, along with an identifier corresponding to the license.

If such a license-restricted file has already been loaded into the memory of a guest OS Application (from another licensed machine), and the file is not available on the Host Machine, the VMM can prevent loading the contents of that file into memory (or unload it if already loaded), and attempt to continue execution without it. If it cannot do so, then the VM Application can instead be suspended. Furthermore, if the Host OS is compliant with license restrictions and entitled to use these files, the VMM can seek to automatically obtain copies of the library files, via the internet, through authorized channels.

### The Meta-File System (MFS)

The MFS presents a mapping from files accessible in the Guest OS to files that are located on Host file-systems (including here portable storage file-systems, networked file systems), as well as Guest file-systems. The mapping information for each file or a group of files is stored in a meta-data entry in the MFS specification. The MFS acts as a bridge between the Guest OS and files on the Host.

As illustrated in FIG. 17, access requests to such files in the Guest OS are intercepted by a shim in the Guest OS to a file-system handler in the VMM. There, the request is checked against the policy constraints of the VM application and of the file being requested, as well as looked up in an MFS database that maps files in the Guest OS view to corresponding files in the Host OS view. If compliant and there is a valid entry in the database, then the file-system requests from the Guest OS are passed as equivalent commands to the Host OS, otherwise, unless further action is taken by the VMM to obtain the file, the Guest OS is notified of the failure. If successful, the Host OS can open the file and return a file handle. The file-system handler in the VMM can then set up a temporary association between the file-handle in the Host OS and the file-handle in the Guest OS and forward all VM Application access requests of that intercepted file-handle as equivalent calls to the Host OS, and forward the corresponding responses back to the VM Application, via the Guest OS shim. If the required file is not present, then depending on application policy and preferences, it can either suspend the process or return a file-not-found response/exception to the guest OS. Some files required by the Guest OS file-system can even be located in the Host file-system within compressed or archival-collections of files (such as .CAB files) or file-system content images. The MFS can handle these mappings by including compression configuration information in the MFS database.

The MFS presents a consistent view of files and folders as seen by the guest OS, so that independent of the underlying host OS details, they can be accessed by the guest OS and applications on the guest OS in a consistent manner (e.g. at a known path location on the guest OS). This enables VM applications reliant on such Host OS content to run across multiple machines even when that content is located in different Host OS path locations, and without being presented a direct view of Host OS folders and file-systems. This provides portability in the virtual machine interactions with the host. Moreover, the content may not even be located on the Host OS, in which case it could be downloaded by the VMM as needed, according to the meta-file description.

### Constructing the MFS Database

Given that the MFS is a mapping from the view of files in Guest OS to files that are located on Host-accessible file-systems, including hard-drives, portable storage file-systems, and networked file systems, it is necessary to resolve and verify the existence of these files.

The MFS meta-data can be produced by an MFS specification. An MFS specification is a collection of unresolved meta-files for all the files that are intended to be present in the execution of a Virtual Machine. Each meta-file contains a list of entries, each entry has an allowable hash value (e.g. MD-5 file checksum) and one or more license IDs that are to be covered to utilise this file. A set of flags can also be included, globally, or per entry, to govern behaviour such as whether or not the presence of the file is mandatory, if the contents of the file need to have a matching hash value, or if it is just the license governing the file that is needed instead of the file itself.

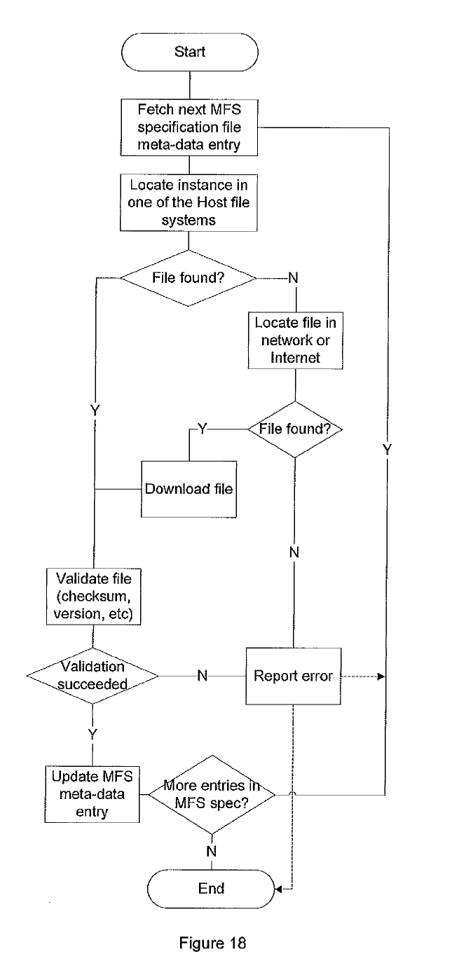

MFS meta-data that associates a desired file in the Guest OS file-system, to a corresponding file in the Host OS file-system, is generated from the MFS Specification and can be stored in a database on the Host machine. The MFS meta-data is produced by resolving and verifying the MFS specification entries. This process, as illustrated in FIG. 18, involves iterating through the set of meta-files in the MFS specification and resolving/verifying file locations. The MFS specification meta-file can contain file path hints, to indicate where the file could be found.

Further mechanisms can also be employed if the file is not found in the hinted location. If the file can be found in one of the Host file-systems, then the process of file verification is taken. After successful file verification, the location is set in the MFS meta-data. If the file cannot be found in one of the Host file-systems, the MFS specification meta-file entries can contain URL information that can be used to download the file from Internet or other network locations.

The verification step can involve the calculation of a hash value (e.g. MD5 checksum) for the file being verified. The resulting hash value is compared with the existing hash values stored in the meta-data. If the values match, then the integrity of the file is confirmed. The verification step can also include checking file version information (e.g. a DLL version number) against the version information located in the file meta-data.

The MFS file meta-data entry can contain extra file access permissions for the Guest OS. It is often useful to restrict file access permissions on many files provided by the MFS and accessed by the guest OS: During its normal operation, the Guest OS can want to make file modifications (e.g. an OS settings file). This can become a problem for most of the files that are located in the Host file-system since such modifications could compromise the integrity of the Host machine. For these files, the MFS can employ a copy-on-write policy, whereby such files are copied to a new writeable location and modified there. As part of the copy-on-write policy, a remapping of the file location from the Host File OS to the new location is done in the corresponding file MFS meta-data entry.

The MFS file meta-data entry can also contain information on license based file access permissions. This allows an authority to provide license based access control to files (or directories). File access can be denied by the authority by revoking the file license. Revoking the license can be done in several ways. In one approach, tokens for licenses are time-limited—a token that has a start time and an end time is checked from the licensor company and signed by the licensor company's private key. The VMM prevents access without a valid signed license token and checks that the current time is within the valid period of the token. Before the expiry of the token, the VMM can automatically try to obtain another token from the licensor. In another approach, at a regular interval from when the application license was created, the VMM can check with the licensor that the license key is valid. It can do so by sending information about the license key, such as its MD-5 checksum to the licensor, over the Internet, and if it finds that it is not valid, the VMM can add it to its local list of invalid licenses, and to the SPSD/SIM storage.

The MFS can also be constructed on-demand. That is, file locations in the MFS specification is not resolved and verified until the first time they are needed during the execution of the VM. When the file is needed, the location resolution and verification described above can be employed.

### Deterministically Constructing a Foundation Memory Image

A set of instructions in a file can be used to describe the formation of a Foundation Memory Image by the VMM. The instructions include triggers that characterises/depicts specific events and commands that are used for specifying actions for the VMM. These instructions can be used in combination with a specified Meta-File-System, to deterministically build a Foundation Memory Image or standardised Ring Images from licensed content found on the Host OS. The set of trigger-events can include (but are not limited to): when the VM executes a specific instruction, when the VM reads or writes to a specific memory location, when the VM has spent a specific number of execution cycles, when the VM has executed a specific number of instructions, when the VM has reached a specific execution time. These event descriptions can also have a periodic nature: occurring every n execution cycles (where n is the specified value), occurring every n executed instructions, occurring every n units of time (where units of time can be standard units of time), etc. When these events occur, they can trigger the specified commands. Such a command can be “save the VM memory” or “take a snapshot of the VM”, or even custom actions that are defined by the VMM API. To illustrate this with an example, this information can contain data that specifies a MFS for the VMM to use, and describes the pair of an event and an action, where the trigger event is the execution of one million cycles of instructions since Virtual Machine power-up, and the action is to save the VM memory state. In presence of this meta-data, the VM should be saved after one million executed cycles.

### Cloud Integration

The file-system on the SPSD can be cloud-backed. That is, the file-system can be only partially present on the flash device, with remaining files accessible via VPN or directly on the cloud.

The local file-system can be tailored this way by utilising symbolic links to another file-system that is attached remotely via the network. In this approach, the remote file system can be mounted on the SPSD itself, or by the connected PC. Policy controls can be placed on files or directories, so that they cannot be replicated on the local file-system, but remain as symbolic links to the network-attached file-system. Localisation, then, involves the replacement of the symbolic link with a remote file or directory. The opposite step involves copying the file to the remote file-system, and then replacing with a symbolic link. If persistent backup is desired, it can also ensure that files in the local file-system are reflected into the remote file-system by copying any changed files over when networking is present. Policy controls can restrict what files are allowed to be localised, and if they are allowed to be localised, whether or not they need to be encrypted.

Existing access control mechanisms in the file-system (such as in Unix) can prevent an unauthorised machine from accessing the data. Such data can be further protected by encryption, with a decryption key that is only made available to the VMM on authorised machines, and not stored on the SPSD itself.

### Security

The files in a file-system can all reside on an encrypted store in the SPSD that is only accessible with a valid password or a valid decryption key. Hardware or software decryption can then transport the files across to the VMM. Alternatively, the encrypted contents could be sent to the VMM and decrypted there. The encrypted store can consist of several logical file-system units, each encrypted with separate encryption key. This provides greater flexibility—e.g. personal files are encrypted with a different encryption key, compared to company owned content. Moreover, a license based mechanism can be employed to check whether to provide access to any of these logical units. When a license is revoked for a particular logical unit, the VMM not only denies access to the data in that logical unit, but it can also be configured to delete the data in that unit. License revocation mechanisms are described in License Management. Furthermore, Access-Policy restrictions can also be configured for such file-systems, so that it is only accessible on certain trusted Host Machines, or by certain trusted VM Applications. Both the license and access-policy compliance and authentication mechanisms can be similar to the regular VM Application case, but with the SPSD challenging the Host and/or VM Applications instead.

### Ring of Synchronisation

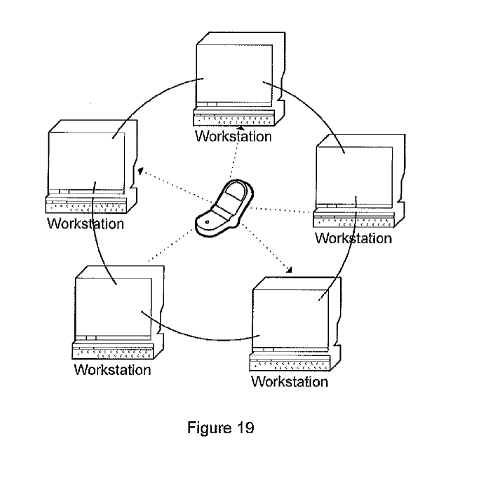

In another synchronisation setup, a number of computers (desktop PCs, laptops, tablets and other computing devices) are paired with the SPSD in a ‘Ring of Synchronisation’ (see FIG. 19). These computers are considered to be actively used by a single user on day to day basis (e.g. an office desktop PC, a laptop and a home computer). This new synchronisation mode aims to further reduce the amount of state that is carried in the SPSD and in return increase the amount of state that is stored in computers that are part of the synchronisation Ring. The reduced amount of state carried in the SPSD brings the immediate benefit of an even faster response from the running VM, since there is less data that is used by the VM which needs to be carried from the SPSD. Moreover, the Ring of synchronisation brings further benefits:
One of the computers from the Ring, nominated as the “base” computer is selected as the model for constructing the VM image that is the common image that is used across all the computers in the Ring. This VM image contains the “look and feel” of the desktop that the user is already familiar with. We refer to this image as the “Ring image”.
The newly created image, which is specific to the Ring can contain user applications, provided that the user contains the appropriate licenses in all the computers that are part of the Ring. Given that this is a standard image across this Ring of computers, these additional applications are saved in the local drives of the Ring computers and therefore do not cause any storage overhead for the SPSD. This brings the user more flexibility in the choice of applications that they can use without the need to install them.
Furthermore, the parts or the complete state(s) of the virtual desktop can be backed up in all the computers that are part of the synchronisation Ring. This not only provides reduced storage needs for the SPSD (and resulting improved response from the VM) but also a reliable backup mechanism due to its inherent redundancy.

The Ring image is created at the “base” computer in the Ring of synchronisation. By using the SPSD, this image is copied to all the computers that become part of the synchronisation Ring. Once all the Ring computers are equipped with this image, the SPSD does not need to keep the Ring image for normal execution of the virtual desktop. The Ring image is based on the host OS environment and the applications of the base computer and contains:
information that relates to the VM
file metadata about the OS and the applications that are intended to be used as part of the Ring image. As described in the section Constructing the MFS database, this metadata is used to bypass the VM and get the file content from the host computer.
Information on personalised settings that constitute the “look and feel” of the desktop on which the Ring specific virtual desktop is based (e.g. the background image, the screensaver, personalised icons, etc.). This information can be e.g. registry settings in Windows OS, and files that contain OS settings.
It can contain user data

The Ring image can also include actual files instead of file metadata. This allows applications that are installed in the base computer but are not installed in other Ring computers to be available in the virtual desktop through the Ring image.

There are a number of possibilities on how the whole virtual desktop state is shared between the Ring image and the SPSD:
1. The Ring image contains the OS and the applications (file-system contents and base memory state). The SPSD contains all the user data and the modifications to the file-system contents and memory state (deltas).
2. The Ring image contains the OS and the applications (file-system contents and base memory state), including some of the user data (e.g. some selected directories). The SPSD contains the remaining part of the user data and the modifications to the file-system content and memory state (deltas).
3. The Ring image contains the OS and the applications (file-system contents and base memory state) and all user data. The SPSD contains the modifications to the file system contents and memory state (deltas). When the SPSD is connected to a computer in the Ring, it backs up all modified files to this computer. It updates its internal meta-data that tracks the state of backup for each computer in the Ring to the latest version. Either the computer or the SPSD can run a check on each file to see if, at its current state, it has been backed up by each member computer in the Ring. If each member has a copy of the most recent version, then that file is removed from the SPSD (by either the PC or SPSD). However, each time a file is modified, it is stored again on the SPSD. Whether a complete file is saved or only changes to that file are saved can also depend on the type of the file, its compressibility, the size of file, and the size of encoding and tracking changes for each PC's version.
4. The Ring image contains all of the elements in point 3 above, but also a snapshot (a consistent view of state) of memory and file-system contents. The SPSD carries the modifications to the file-system contents and memory state that are sufficient to restore the virtual desktop execution in any of the Ring members. The SPSD stores the merged deltas that allow the computer with the oldest snapshot to be restored in the most recent state. This approach would allow any computer in the Ring to execute the virtual desktop without the presence of the SPSD, which can be useful in case of an accidental loss of the SPSD.

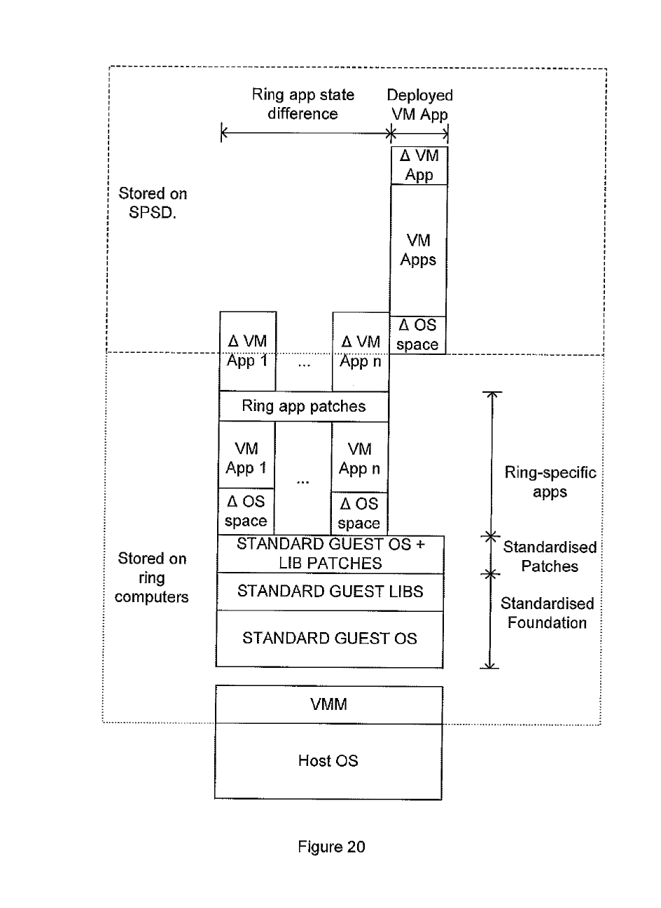

FIG. 20 depicts the memory structure of the Ring image and the corresponding data that is stored on the SPSD. The memory structure of the Ring Image, with only changes to the VM Application state stored on the SPSD device. Compatibility with Portable-Mode VM Applications is also shown here with the entire right-most VM Application stored on the SPSD. In addition to the standardised foundation, the Ring image can also contain one or more VM Apps that are specific to the Ring. The SPSD can still include other deployed VM Apps that are deployed as described as part of the standardised foundation image. It is clear from the illustration that the SPSD does not need to store the loaded Ring apps. Moreover, the state (and the corresponding state difference) of these apps can be partly stored in Ring computers, as described in the four possibilities above.

### Host OS Suspend

The aim of this feature is to provide a mechanism to suspend the execution of the host OS (e.g. Microsoft Windows, Linux, etc), load up another (preferably smaller) customised OS kernel in order to continue using the computer through the new OS kernel and after it's use, resume the execution of the original host OS at the point of suspend. The new kernel could be used e.g. to start a VMM and execute a virtual desktop or could be used for any other purpose. It is important that the execution of the new kernel does not affect our ability to resume the original host OS.

This process includes the following steps:
1. Suspend the execution of the host OS. This step should not be confused with the OS operations such as standby, sleep, or s2ram (in Linux). It involves a kernel process (a process with kernel execution privileges) that takes the control of execution from the normal kernel dispatcher. This process saves the execution state of the OS and suspends/unloads device drivers where necessary. The suspension/unloading of device drivers is necessary in the cases where later restoration of hardware state is not possible or unreliable (e.g. some video hardware).
2. Next, the process performs the following (i) creates a map of the memory that was used by the host OS (and all the running applications), and (ii) frees required memory locations, by relocating host OS pages to other physical pages in memory or to non-volatile storage as necessary. Both of these operations are done as part of preparations for loading the new kernel. The relocation can be required by the incoming kernel since some parts of the incoming kernel may need to be placed on fixed physical memory locations which were in use by the outgoing OS. The map of the memory that is used by the original (outgoing) host OS is passed to the new kernel memory manager in order to make sure that these memory locations are not modified by the incoming kernel.
3. The new, intermediate kernel is loaded with the necessary device drivers. At this point application (e.g. VMM) execution under the new kernel may begin. It has to be noted here that all the memory that has been mapped as belonging to the original (outgoing) host OS could be paged out to non-volatile storage if the memory manager deems it necessary. However, when the current kernel finishes the execution of the application and the resumption of the original host OS is requested, these pages can be restored back to their original location in physical RAM.
4. The resumption of the original host OS should follow the end of the intermediate kernel work. In order to make this possible, the intermediate kernel restores any memory relocations performed in step 2, resumes/reloads the suspended device drivers performed in step 1, restores the execution state and hands over control to the original OS dispatcher.

### Summary of Usage Models

There are two main modes of encapsulating Virtual Desktops:
App-level VM—An application per virtual machine, with windows of the application visible as part of a desktop environment that lies outside the App-level VM. Each app-level VM is stored on the SPSD and can be run on any machines. Policy and License restrictions of the VMM are enforced on a per-Application level, and Applications can be migrated individually to other SPSD devices.
Single App with Desktop—A complete desktop environment, but with multiple sub-applications inside a single VM. As per the App-level VM, the environment is portable and can be loaded up on any Host PC. However, the Policy and License control restrictions apply to the entire Desktop, moreover these sub-applications cannot be easily and separately migrated to other SPSD devices, but the entire desktop can be.

There are two main modes of operation that affects portability and storage footprint:
Portable Mode—VM Applications in Portable Mode are stored on the SPSD device, so that they can be brought up on any Host machine that has the VMM running.
Ring Mode—the VM Applications in Ring-mode are not usable outside the set of Host machines that form the Ring of synchronisation. Rather than carrying the entire VM Application, only changes to the VM Applications are carried on the SPSD, thus reducing SPSD storage requirements compared to the Portable Mode.

These Usage Models are compatible with each other, i.e. some Applications may be Ring-mode and so can only be used inside the Ring of synchronisation, whereas some Applications may be non-Ring mode and thus are portable anywhere. Such Applications can further be of the Single-App variety, containing only a single usable application, whilst other Applications may contain a desktop of sub-applications.

In order to help a user be compliant with the terms of software licenses, when running a licensed-OS as the guest OS, or utilising other licensed content, there are several capabilities that can be offered:
License not needed from Host—this is the case when a separate exclusive license has already been obtained for the SPSD, or if the Host file-system pass-through is used by the MFS, to directly utilise licensed components on the Host machine whilst the Host OS is running.
Suspend and borrow license—here the Host PC is suspended along with its licensed Applications/OS/content. The License is then borrowed from the Host machine whilst in use.
Suspend and transfer license—upon installation on a primary machine, the Host's license for SPSD-installed licensed-content is assumed to be transferred to the SPSD device. It is up to the user to ensure that their Host license are not used simultaneously with the SPSD. When the SPSD device is connected to this Host, the Host OS is suspended to ensure compliance.

As an example for the first case, consider the instance of a Host OS being a commercial OS, and the Guest OS bundled in the Foundation Image being an open-source operating system such as FreeBSD. An open-source compatibility layer may also be bundled in the Foundation Image so that Applications written for the commercial OS can be run in the VMM. The MFS may then allow licensed components from the Host OS, such as libraries, fonts and other items, to be utilised in the compatibility layer as the Host machine already has a license for their use.

No doubt many other effective alternatives will occur to the skilled person. It will be understood that the invention is not limited to the described embodiments and encompasses modifications apparent to those skilled in the art lying within the spirit and scope of the claims appended hereto.

1. A method of providing a transferable computing environment, wherein said computing environment is operable on a first, computing machine and is able to be transferred to a second, portable device, and wherein said transfer retains an operational state of said computing environment, the method comprising:
providing a said first computing machine, wherein said first computing machine has a host operating system and a virtual machine monitor running on said host operating system;
providing a plurality of virtual machines each able to run on said virtual machine monitor, wherein each said virtual machine includes a guest operating system to run using said virtual machine and an application residing in said virtual machine;
portioning each said virtual machine into first and second portions, wherein said first portion of said virtual machine comprises at least a common portion of said virtual machines shared between said plurality of virtual machines, said common portion including at least a common part of said guest operating system, and wherein said second portion of said virtual machine comprises application state data defining a state of operation of said application specific to operation of the application in the virtual machine;
providing said first computing machine with at least a useable part of one of said virtual machines;
using said application in said at least one virtual machine on said first computing machine to define a said operational state of said application; and
transferring at least part of said second portion of said at least one virtual machine to said portable device to enable said application in said at least one virtual machine to be used, in combination with said common portion of said virtual machines, on a second computing machine.

2. A method of providing a transferable computing environment as claimed in claim 1 wherein said second portion of a virtual machine has an application portion configured to cooperate with said common portion of said plurality of virtual machines to implement an application and an application state update portion comprising application difference data and operating system difference data together defining changes to a state of both said application and said guest operating system resulting from operation of said application on said guest operating system, the method further comprising transferring at least part of said application state update portion of said virtual machine between said portable device and said first computing machine or a further computing machine.

3. (canceled)

4. A method of providing a transferable computing environment between a plurality of computing machines, the method comprising:
providing each of a plurality of computing machines with both a virtual machine monitor and a host operating system,
providing a virtual machine able to run on said virtual machine monitor, wherein said virtual machine includes a guest operating system to run using said virtual machine and an application residing in said virtual machine,
portioning said virtual machine into first and second portions, wherein said first portion of said virtual machine comprises at least a common portion of said virtual machine common to each of said plurality of computing machines, said common portion including at least a common part of said guest operating system, and wherein said second portion of said virtual machine comprises application state data defining a state of operation of said application specific to operation of the application in the virtual machine,
providing a portable device with said second portion of said virtual machine; and
transferring at least a useable part of said second portion of said virtual machine from said portable device to enable said application in said virtual machine to be used, in combination with said common portion of said virtual machines, on a first of said plurality of computing machines.

5. A method as claimed in claim 4, the method further comprising:
transferring at least a useable part of said second portion of said virtual machine from said portable device to enable said application in said virtual machine to be used, in combination with said common portion, on a second of said plurality of computing machines.

6. A method as claimed in claim 5 further comprising updating said second portion of said virtual machine on said portable device using data from use of said application on said first of said plurality of computing machines prior to transferring at least a part of said second portion of said virtual machine from said portable device to said second of said plurality of computing machines.

7. A method as claimed in claim 6, further comprising a plurality of such virtual machines, each virtual machine including a guest operating system to run using said virtual machine and an application residing in said virtual machine, wherein each virtual machine comprises said common portion shared between said plurality of virtual machines, wherein said common portion of said virtual machines is common to each of said plurality of computing machines;
transferring at least said useable part of said second portion of each of said plurality of virtual machines from said portable device to enable each of said application in said virtual machine to be used, in combination with said first portion of said virtual machines, on said first of said plurality of computing machines.

8. (canceled)

9. A method as claimed in claim 7 wherein said second of said plurality of computing machines lacks said application portion, and wherein use of said application in said second of said plurality of computing machines requires connection of said portable device to said second of said plurality of computing machines.

10. (canceled)

11. A method as claimed in claim 7, wherein said plurality of virtual machines includes at least one subset of application suite virtual machines comprising a respective subset of said applications, wherein said applications of said subset are interoperable, wherein said application state update portions of said application suite virtual machines include interprocess communication software state data common to said subset of applications, and wherein said transferring comprises transferring said common interprocess communication software state data of said application suite virtual machines to said portable device.

12. (canceled)

13. A method of providing a transferable computing environment as claimed in claim 7 wherein said guest operating system and said host operating system include corresponding files, further comprising a table linking one or more files of said guest operating system to said corresponding files of said host operating system to enable a said corresponding file to be retrieved, and wherein said guest operating system lacks said corresponding file.

14. A method of providing a transferable computing environment as claimed in claim 10 wherein said using of said application on said first computing machine comprises retrieving at least some of the data from a said corresponding file from said host operating system via said guest operating system.

15. A method of providing a transferable computing environment as claimed in claim 7 further comprising storing platform independent property data on said portable device for said application in said at least one virtual machine, said platform independent property data comprising data defining a state of said application independent of a processor or operating system on which said application is executing,
and using a corresponding mobile version of said application in said at least one virtual machine on said portable device in combination with said common portion of said virtual machines by accessing said platform independent property data using said corresponding mobile version of said application.

16. A method of providing a transferable computing environment as claimed in claim 7 further comprising storing a licence for said application in said at least one virtual machine on said portable device, cryptographically linked to a unique identifier of one or more of: said portable device, a user of said portable device, a telecoms service provider providing a telecoms service to said portable device, and a manufacturer of said portable device.

17. A method of providing a transferable computing environment as claimed in claim 16 wherein said licence, or tokens enabling use of said licence, is configured to automatically expire at regular intervals, the method further comprising refreshing said licence to maintain usability of said application in said at least one virtual machine.

18. (canceled)

19. A method of providing a transferable computing environment as claimed in claim 7, further comprising providing an interface application to enable use of resources of said portable device by said application in said at least one virtual machine when operating on said portable device, and wherein said virtual machine and one or both of said interface application and said guest operating system include an API to enable respectively, one or both of use of a resource of said first computing machine by said application in said at least one virtual machine on said portable device, and use of a resource of said portable device by said application in said at least one virtual machine on said first computing machine.

20. (canceled)

21. A computing machine or portable device storing a virtual machine, wherein the VM virtual machine is as recited in claim 7.

22. A method of transferring a transferable computing environment between a plurality of computing machines, the method comprising:
providing each of a plurality of computing machines with a common computing environment, said common computing environment comprising a guest operating system and a virtual machine monitor, said guest operating system being common to each of said plurality of computing machines,
portioning a virtual machine operable to run on said virtual machine monitor into first and second portions, said first portion comprising a common portion of said virtual machine common to each of said plurality of computing machines, said second portion defining a state of operation of said virtual machine, said common computing environment on each of said plurality of computing machines further comprising said first portion of said virtual machine;
providing a first of said plurality of computing machines with said second portion of said virtual machine;
transferring said second portion of said virtual machine to a portable device; and
transferring said second portion of said from said portable device to a second of said plurality of computing machines.

23. (canceled)

24. A method as claimed in claim 22 further comprising storing user data on said portable device, and when connected to one of said plurality of computing machines, said virtual machine accessing said user data on said portable device.

25. A method as claimed in claim 24 further comprising storing virtual machine application data in said common computing environment, transferring virtual machine application change data defining changes to said virtual machine application data made by said first of said plurality of computing machines from said first of said plurality of computing machines to said portable device,
updating said virtual machine application data in said common computing environment on said second of said plurality of computing machines using said virtual machine application change data; and
comparing said virtual machine application change data with said virtual machine application data in each of said plurality of computing machines, and dependent on said comparison, removing said virtual machine application change data from said portable device.

26. (canceled)

27. A computing device or portable device storing a virtual machine, wherein the virtual machine is as recited in claim 24.

28. A portable device for managing and transferring a transferable computing environment, the transferable computing environment comprising a guest operating system, a virtual machine monitor running on a host operating system, and a virtual machine running said guest operating system, comprising state data items defining a state of operation of said virtual machine, the portable device comprising:
an interface for communicating with a computing machine, non-volatile memory to store said state data items, and memory storing priority data defining a preferred transfer order of a plurality of said state data items;
a program store storing code and a processing element coupled to said interface, said non-volatile memory and said program store, the code comprising:
code to receive said state data items from a first computing machine via said interface and store said state data items in said non-volatile memory;
code to send said plurality of said state data items from said non-volatile memory to said first computing machine or a second computing machine, wherein an order of said sending is dependent on said priority data; and
code to determine said priority data, wherein said determination is dependent on a usage history of said virtual machine on said first computing machine.

29. (canceled)

30. (canceled)

31. (canceled)

32. A portable device as claimed in claim 28 wherein said state data items further comprise platform independent property data comprising data defining a state of said application independent of a processor or operating system on which said application is executing, said portable device further comprising a corresponding portable version of said application in said virtual machine, said portable device further comprising code to access said platform independent property data using said corresponding mobile versions of said application.

33. (canceled)

34. A method of providing a transferable computing environment as claimed in claim 2, further comprising transferring at least said second portion of said at least one virtual machine to a third, computing machine, and using said application in said at least one virtual machine on said third computing machine, wherein one or both of said application portion and said application state update portion of said virtual machine include at least a portion of a file associated with or licensed with said host operating system, the method further comprising tagging said transferred portion of said at least one virtual machine to indicate presence of said portion of said file of said host operating system, and wherein said using of said application in said at least one virtual machine on said third computing device further comprises checking that said at least a portion of said file indicated by said tagging exists on said third computing device, and restricting use of said application in said at least one virtual machine on said third computing device if said at least a portion of said file indicated by said tagging does not exist on said third computing device.
